(19) United States
(12) Patent Application Publication
(10) Pub. No.: US 2024/0386318 A1
(43) Pub. Date: Nov. 21, 2024

(54) CHECKPOINT AVERAGING TO MITIGATE AND/OR ELIMINATE CATASTROPHIC FORGETTING OF MACHINE LEARNING MODEL(S) IN DECENTRALIZED LEARNING THEREOF

(71) Applicant: GOOGLE LLC, Mountain View, CA (US)

(72) Inventors: Yuxin Ding, San Francisco, CA (US); Lillian Zhou, Mountain View, CA (US); Mingqing Chen, Saratoga, CA (US); Rajiv Mathews, Sunnyvale, CA (US); Andrew Hard, Menlo Park, CA (US); Sean Augenstein, San Mateo, CA (US)

(21) Appl. No.: 18/386,431

(22) Filed: Nov. 2, 2023

Related U.S. Application Data
(60) Provisional application No. 63/466,976, filed on May 16, 2023.

(51) Int. Cl. G06N 20/00

(52) U.S. Cl. CPC G06N 20/00

(57) ABSTRACT

Implementations described herein are directed to techniques for mitigating and/or eliminating catastrophic forgetting of a global machine learning (ML) model during decentralized learning thereof. Remote processor(s) of a remote system can initially train a global ML model based on server data that is accessible by the remote system. In subsequent decentralized learning of the global ML model, the remote processor(s) can utilize various checkpoint averaging techniques. As described herein, these various checkpoint averaging techniques can include, but are not limited to, a static checkpoint averaging technique, a dynamic checkpoint averaging techniques, and/or a mixed centralized and decentralized training technique.

### BACKGROUND

Decentralized learning of machine learning (ML) model(s) is an increasingly popular ML technique for updating ML model(s) due to various privacy considerations. In one common implementation of decentralized learning, an on-device ML model is stored locally on a client device of a user, and a global ML model, that is a cloud-based counterpart of the on-device ML model, is stored remotely at a remote system (e.g., a server or cluster of servers). During a given round of decentralized learning, the client device can check-in to a population of client devices that will be utilized in the given round of decentralized learning, download a global ML model or weights thereof from the remote system (e.g., to be utilized as the on-device ML model), generate an update for the weight of the global ML model based on processing instance(s) of client data locally at the client device and using the on-device ML model, and upload the update for the weight of the global ML model back to the remote system and without transmitting the instance(s) of the client device. The remote system can utilize the update received from the client device, and additional updates generated in a similar manner at additional client devices and that are received from the additional client devices, to update the weights of the global ML model.

Notably, the global ML model can be initially trained based on server data that is available to the remote system, and then fine-tuned using decentralized learning as described above. However, the distribution of data differs between the server data that is utilized to initially train the global ML model and the client device that is utilized by the respective client devices in subsequently generating updates for fine-tuning the global ML model. As a result, the global ML model can catastrophically forget information learned during the initial training and based on the server data. Accordingly, there is a need in the art for techniques to mitigate and/or eliminate the effects of catastrophic forgetting of the global ML model during the subsequent fine-tuning of the global ML model using decentralized learning.

### SUMMARY

Implementations described herein are directed to techniques for mitigating and/or eliminating catastrophic forgetting of a global machine learning (ML) model during decentralized learning thereof. Remote processor(s) of a remote system can initially train a global ML model based on server data that is accessible by the remote system. In subsequent decentralized learning of the global ML model, the remote processor(s) can utilize various checkpoint averaging techniques. By using one or more of these various checkpoint averaging techniques, the effects of catastrophic forgetting of the global ML model can be mitigated and/or eliminated during the decentralized learning of the global ML model.

In some implementations, the remote processor(s) can implement a static checkpoint averaging technique. In these implementations, and during a given round of decentralized learning of the global ML model, the remote processor(s) can receive a plurality of client updates from a plurality of corresponding client devices that are participating in the given round of decentralized learning, identify a checkpoint version of the global ML model that is stored remotely at the remote system, generate a decentralized version of the global ML model based on the checkpoint version of the global ML model and based on the plurality of client updates received from the plurality of corresponding client devices, and generate an averaged version of the global ML model based on the checkpoint version of the global ML model and based on the decentralized version of the global ML model.

Notably, in these implementations, the checkpoint version of the global ML model can be the global ML model that is initially trained based on the server data that is accessible by the remote system. Accordingly, the decentralized version of the global ML model can be the global ML model that is initially trained and subsequently updated based on the client updates received during the given round of decentralized learning. Further, the averaged version of the global ML model can be a weighted average of the decentralized version of the global ML model and the global ML model that is initially trained.

In these implementations, the remote processor(s) can repeat this process for additional rounds of decentralized learning of the global ML model to generate additional averaged versions of the global ML model. The additional averaged versions of the global ML model are generated based on additional decentralized versions of the global ML model that is initially trained and subsequently updated based on additional client updates received during each additional round of decentralized learning, and the global ML model that is initially trained. Further, and subsequent to the additional rounds of decentralized learning of the global ML model being completed, the remote processor(s) can select the averaged version of the global ML model (or one of the additional averaged versions of the global ML model) to be deployed as the global ML model. By deploying the averaged version of the global ML model (or one of the additional averaged versions of the global ML model) in lieu of the global ML model that is initially trained and in lieu of the decentralized version of the global ML model, the deployed global ML model is more robust to the effects of catastrophic forgetting. Put another way, by implementing the static checkpoint averaging technique, the deployed global ML model is better suited for subsequently processing data that is similar to both the server data utilized to initially train the global ML model and client data utilized by the plurality of client devices in generating the corresponding client updates for the global ML model.

In additional or alternative implementations, the remote processor(s) can implement a dynamic checkpoint averaging technique. In these implementations, the remote processor(s) can receive a corresponding plurality of client updates from a plurality of corresponding client devices during each of N rounds of decentralized learning of the global ML model (e.g., where N is a positive integer that is one or greater than one and that is a configurable parameter), and generate and/or update a decentralized version of the global ML model based on the checkpoint version of the global ML model and based on the corresponding plurality of client updates received from the plurality of corresponding client devices.

However, in implementing the dynamic checkpoint averaging technique, and in contrast with the static checkpoint averaging technique, the remote processor(s) may not generate the averaged version of the global ML model after each of the N rounds of decentralized learning. Rather, the remote processor(s) generate the averaged version of the global ML model after the N rounds of decentralized learning. Put another way, the remote processor(s) may continue generating and/or updating the decentralized version of the global ML model for 5 rounds of decentralized learning or 10 rounds of decentralized learning (or however many N rounds that are specified). Subsequent to the N rounds of decentralized learning being completed, the remote processor(s) can utilize a most recently generated and/or updated decentralized version of the global ML model and the checkpoint version of the global ML model to generate the averaged version of the global ML model.

Further, in implementing the dynamic checkpoint averaging technique, and in contrast with the static checkpoint averaging technique, the remote processor(s) can distribute the averaged version of the ML model for utilization by a corresponding plurality of additional client devices during subsequent N rounds of decentralized learning of the global ML model. Accordingly, in generating corresponding additional client updates for the global ML model, corresponding additional client devices can utilize the averaged version of the global ML model for each of the subsequent N rounds of decentralized learning of the global ML model.

In these implementations, the remote processor(s) can repeat this process for additional N rounds of decentralized learning of the global ML model to generate additional averaged versions of the global ML model. The additional averaged versions of the global ML model are generated based on additional decentralized versions of the global ML model that is initially trained and subsequently updated based on additional client updates received during the additional N rounds of decentralized learning, and the global ML model that is initially trained. Further, and subsequent to the additional N rounds of decentralized learning of the global ML model being completed, the remote processor(s) can select the averaged version of the global ML model (or one of the additional averaged versions of the global ML model) to be deployed as the global ML model. By deploying the averaged version of the global ML model (or one of the additional averaged versions of the global ML model) in lieu of the global ML model that is initially trained and in lieu of the decentralized version of the global ML model, the deployed global ML model is more robust to the effects of catastrophic forgetting. Put another way, by implementing the dynamic checkpoint averaging technique, the deployed global ML model is better suited for subsequently processing data that is similar to both the server data utilized to initially train the global ML model and client data utilized by the plurality of client devices in generating the corresponding client updates for the global ML model.

In additional or alternative implementations, the remote processor(s) can implement a mixed centralized and decentralized training technique. In these implementations, the remote processor(s) can receive a corresponding plurality of client updates from a plurality of corresponding client devices during each of N rounds of decentralized learning of the global ML model (e.g., where N is a positive integer that is one or greater than one and that is a configurable parameter), and generate and/or update a decentralized version of the global ML model based on the checkpoint version of the global ML model and based on the corresponding plurality of client updates received from the plurality of corresponding client devices. Put another way, in implementing the mixed centralized and decentralized training technique, and similar to the dynamic checkpoint averaging technique, the remote processor(s) do not generate the averaged version of the global ML model after each of the N rounds of decentralized learning.

However, in implementing the mixed centralized and decentralized training technique, and in contrast with the dynamic checkpoint averaging technique, the remote processor(s) can continue training the checkpoint version of the global ML model based on additional server data that is accessible by the remote system during M rounds of centralized learning of the global ML model to generate remote updates (e.g., where M is a positive integer that is one or greater than one and that is a configurable parameter separate from N). Put another way, as the N rounds of decentralized learning progress and the decentralized version of the global ML model is generated and/or updated, the remote processor(s) can, in parallel, perform M rounds of centralized learning of the global ML model to generate a centralized version of the global ML model. Subsequent to the N rounds of decentralized learning being completed and the M rounds of centralized learning being completed, the remote processor(s) can utilize a most recently generated and/or updated decentralized version of the global ML model and a most recently generated and/or updated centralized version of the global ML model to generate the averaged version of the global ML model.

Further, in implementing the mixed centralized and decentralized training technique, and similar to the dynamic checkpoint averaging technique, the remote processor(s) can distribute the averaged version of the ML model for utilization by a corresponding plurality of additional client devices during subsequent N rounds of decentralized learning of the global ML model. Further, the remote processor(s) utilize the averaged version of the ML model for utilization during subsequent M rounds of centralized learning of the global ML model. Accordingly, in generating corresponding additional client updates for the global ML model, corresponding additional client devices can utilize the averaged version of the global ML model for each of the subsequent N rounds of decentralized learning of the global ML model. Further, in generating corresponding additional remote updates for the global ML model, the remote processor(s) can utilize the averaged version of the global ML model for each of the subsequent M rounds of centralized learning of the global ML model.

In these implementations, the remote processor(s) can repeat this process for additional N rounds of decentralized learning of the global ML model and additional M rounds of centralized learning of the global ML model to generate additional averaged versions of the global ML model. Further, and subsequent to the additional N rounds of decentralized learning of the global ML model and the additional M rounds of centralized learning being completed, the remote processor(s) can utilize the final averaged version of the global ML model to be deployed as the global ML model. By deploying the final averaged version of the global ML model in lieu of the global ML model that is initially trained, in lieu of the decentralized version of the global ML model, and in lieu of the centralized version of the global ML model, the deployed global ML model is more robust to the effects of catastrophic forgetting. Put another way, by implementing the mixed centralized and decentralized training technique, the deployed global ML model is better suited for subsequently processing data that is similar to both the server data utilized to initially train the global ML model and client data utilized by the plurality of client devices in generating the corresponding client updates for the global ML model.

As used herein, a “round of decentralized learning” may be initiated when the remote processor(s) identify a population of client devices that have checked-in for decentralized learning, or when the remote processor(s) transmit data to a population of client devices for purposes of updating a global ML model. The data that is transmitted to the population of client devices for purposes of updating the global ML model may include, for example, global weights of the global ML model, data that may be processed by the client devices of the population in generating the corresponding client updates (e.g., audio data, vision data, textual data, etc.), and/or any other data. Further, the round of decentralized learning may be concluded when the remote processor(s) receive the corresponding client updates from the client devices, or when the remote processor(s) generate and/or update the different versions of the global ML model. As used herein, a “round of centralized learning” may be initiated when the remote processor(s) initiate training and/or updating of the global ML model at the remote system. Further, the round of centralized learning may be concluded when the remote processor(s) generate a remote update and/or update the different versions of the global ML model based on the remote update.

The above description is provided as an overview of some implementations of the present disclosure. Further description of those implementations, and other implementations, are described in more detail below.

### BRIEF DESCRIPTION OF THE DRAWINGS

FIG. 1A, FIG. 1B, FIG. 1C, and FIG. 1D depict example process flows that demonstrate various aspects of the present disclosure, in accordance with various implementations.

FIG. 2 depicts a block diagram of an example environment in which implementations disclosed herein may be implemented.

FIG. 3 depicts a flowchart illustrating an example method of a static checkpoint averaging technique utilized in decentralized learning of a global machine learning (ML) model, in accordance with various implementations.

FIG. 4 depicts a flowchart illustrating an example method of a dynamic checkpoint averaging technique utilized in decentralized learning of a global machine learning (ML) model, in accordance with various implementations.

FIG. 5 depicts a flowchart illustrating an example method of a mixed centralized and decentralized training technique utilized in decentralized learning of a global machine learning (ML) model, in accordance with various implementations.

FIG. 6 depicts an example architecture of a computing device, in accordance with various implementations.

### DETAILED DESCRIPTION

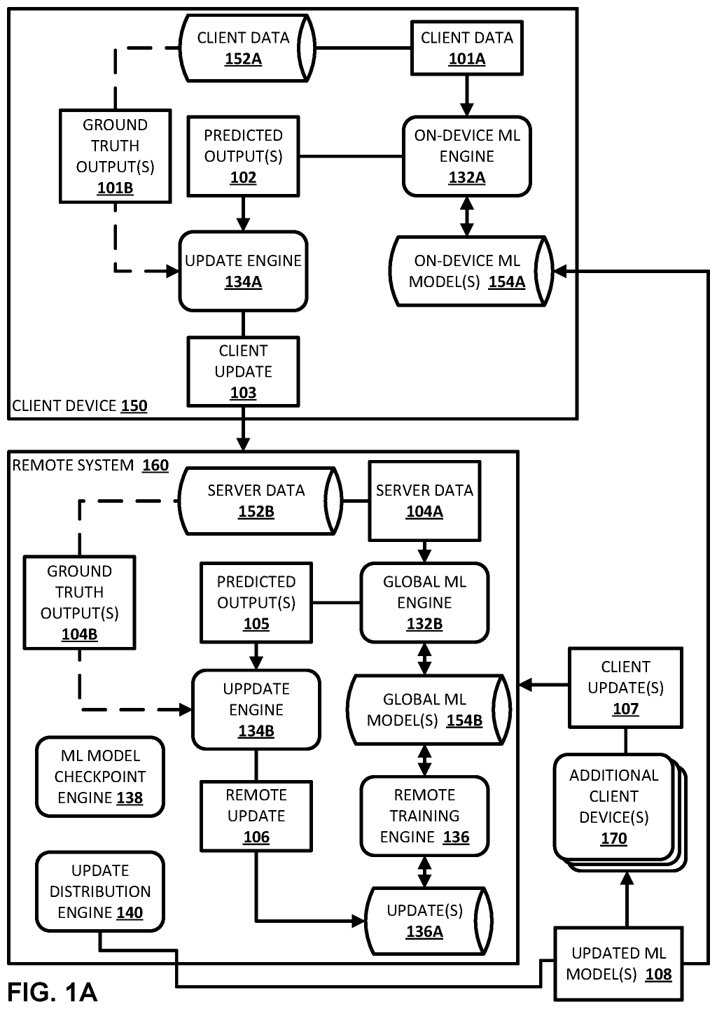

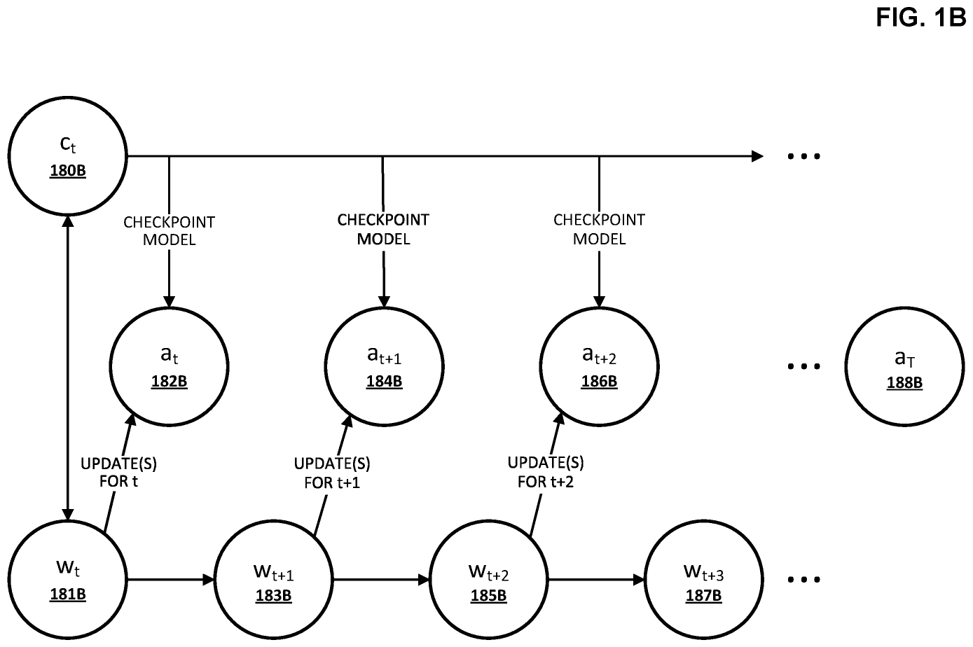

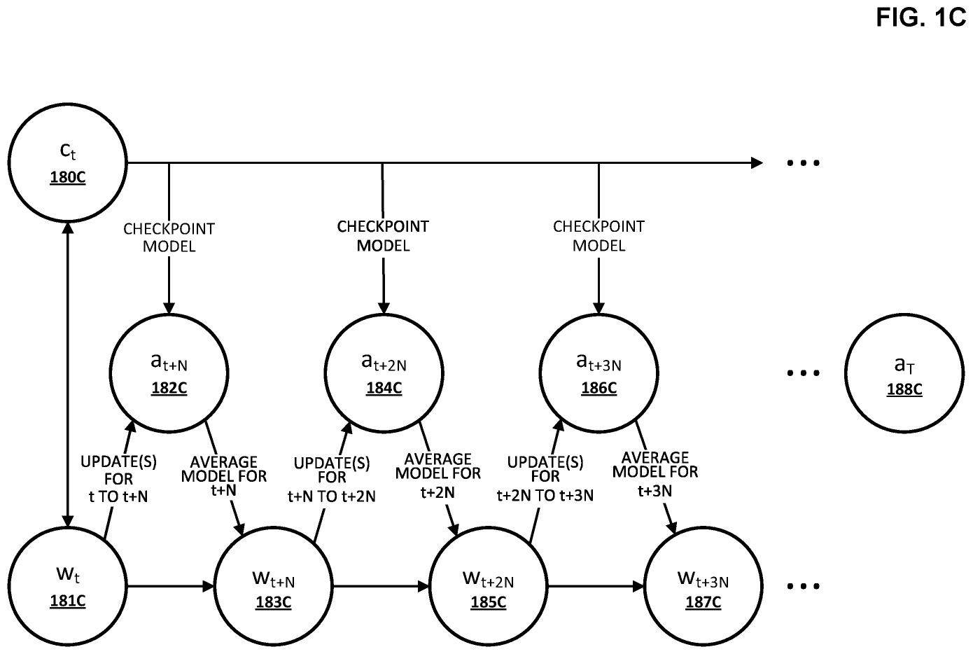

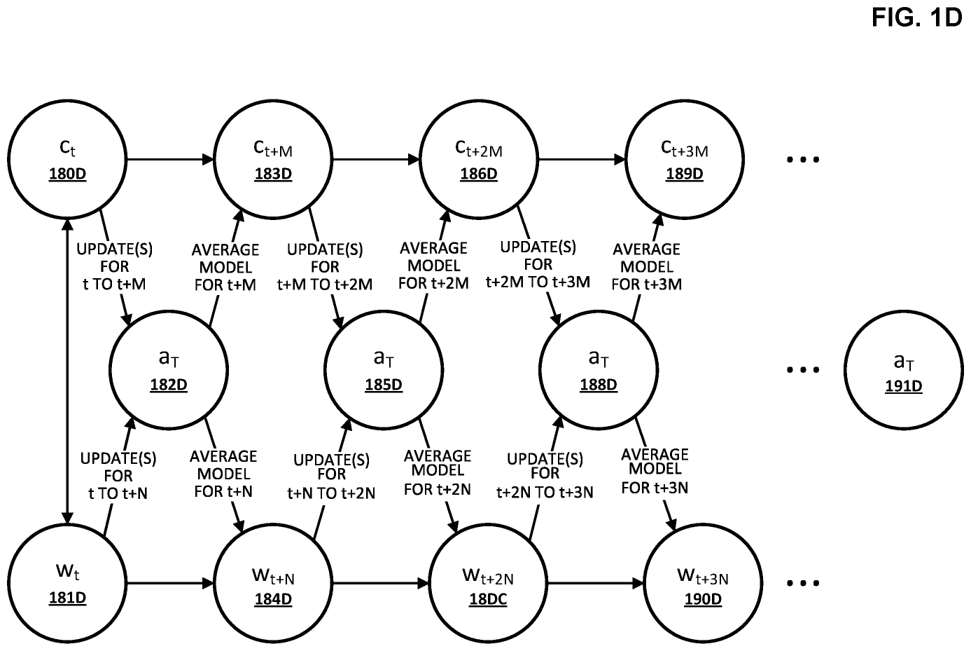

Turning now to FIGS. 1A-1D, example process flows that demonstrate various aspects of the present disclosure are depicted. Referring specifically to FIG. 1A, a client device 150 is illustrated in FIG. 1A, and includes the components that are encompassed within the box of FIG. 1A that represents the client device 150. Further, a remote system 160 is illustrated in FIG. 1A, and includes the components that are encompassed within the box of FIG. 1A that represents the remote system 160. Moreover, additional client device(s) 170 are illustrated in FIG. 1A, and each include the same or similar components that are encompassed within the box of FIG. 1A that represents the client device 150. Initially, the remote system 160 can train a global machine learning (ML) model based on server data stored in server data database 152B that is accessible to the remote system 160 by performing rounds of centralized learning of the global ML model. Notably, the remote system 160 can store the initially trained global ML model in global ML model(s) database 154B as a checkpoint version of the global ML model. Subsequent to the remote system 160 initially training the global ML model based on server data, the remote system 160 can initialize rounds of decentralized learning of the global ML model (e.g., via the client device 150 and/or the additional client device(s) 170) and/or further rounds of centralized learning of the global ML model (e.g., via the remote system 160) to further train the global ML model.

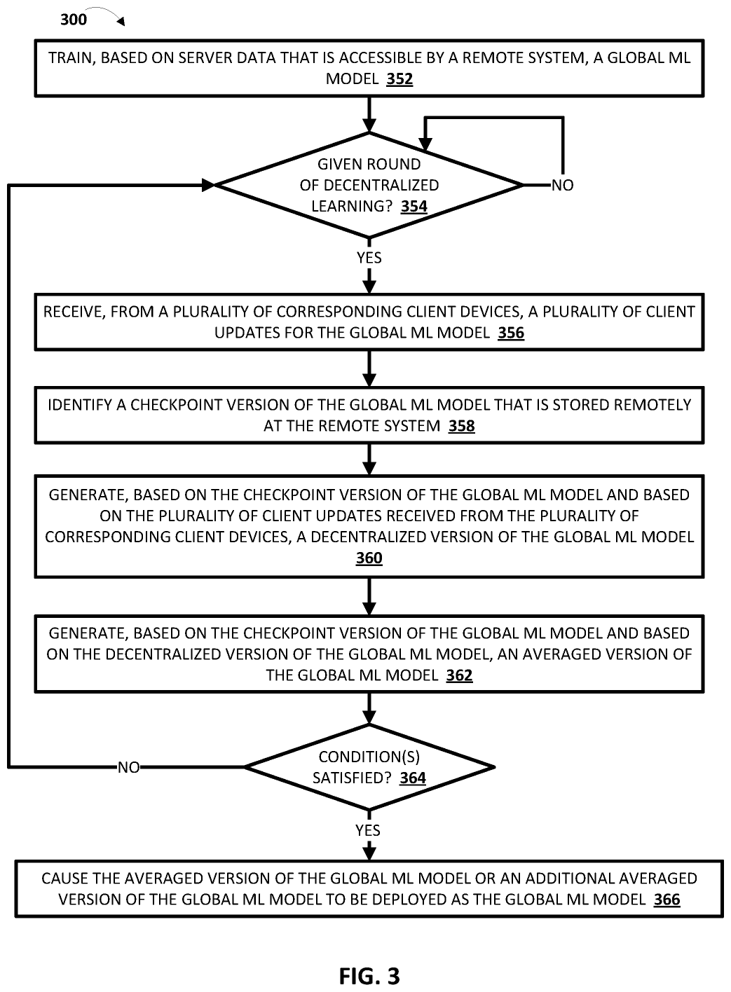

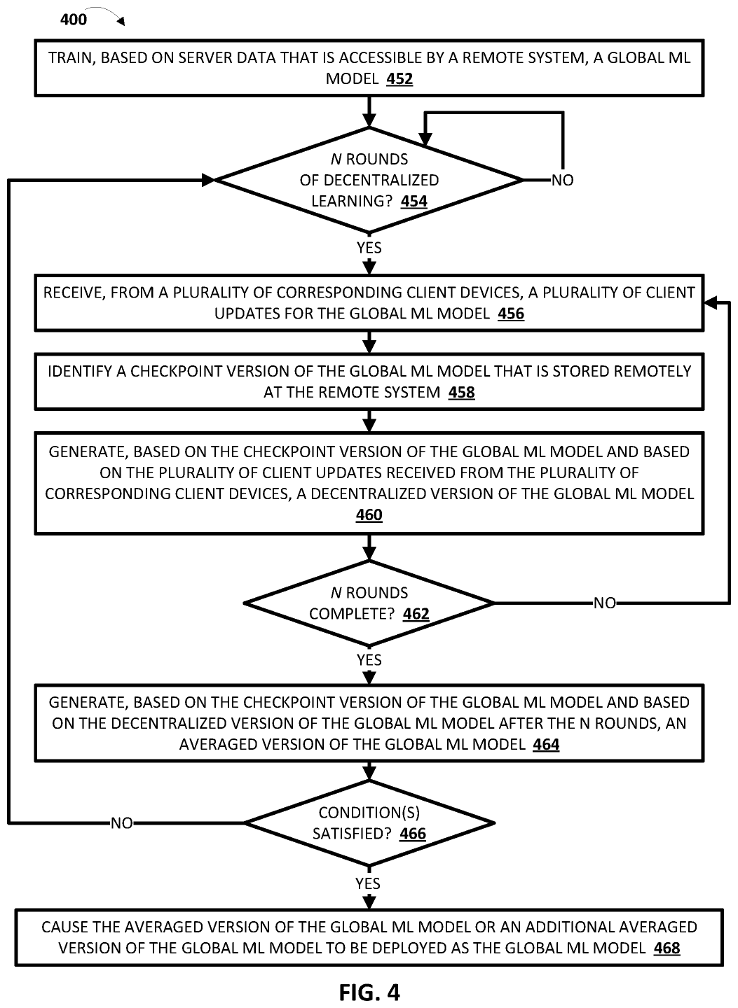

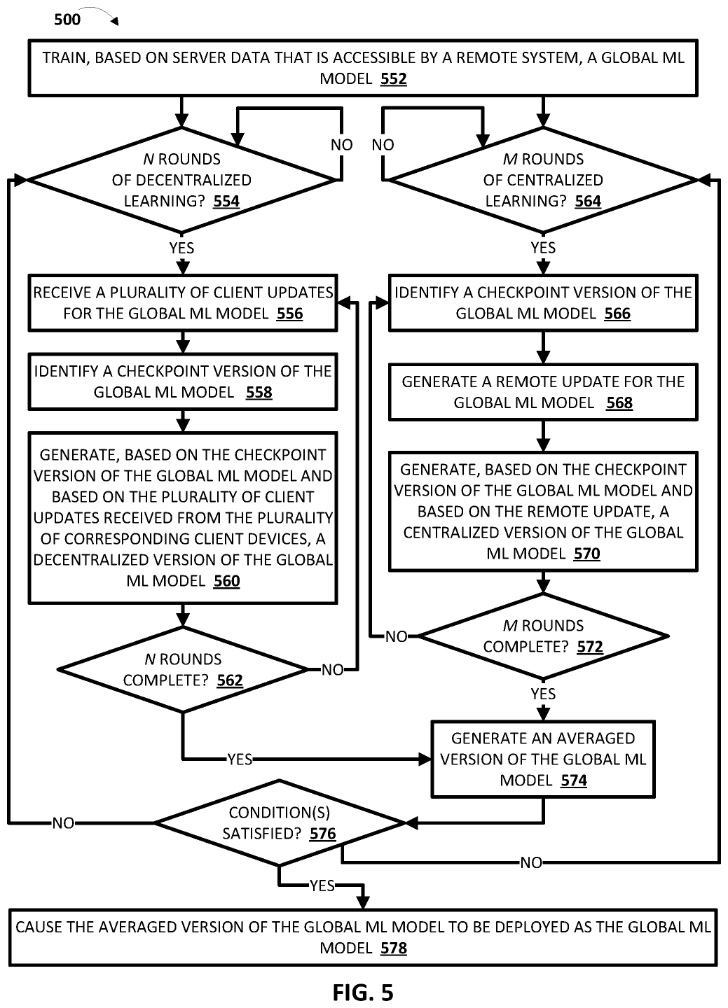

As described in more detail herein (e.g., with respect to FIGS. 1B-1D, 3, 4, and 5), the remote system 160 can implement various checkpoint averaging techniques to mitigate and/or eliminate catastrophic forgetting of the global ML model during the decentralized learning of the global ML model through utilization of a ML model checkpoint engine 138 of the remote system 160. In some implementations, and as described with respect to FIGS. 1B and 3, the remote system 160 can implement a static checkpoint averaging technique. In additional or alternative implementations, and as described with respect to FIGS. 1C and 4, the remote system 160 can implement a dynamic checkpoint averaging technique. In additional or alternative implementations, and as described with respect to FIGS. 1D and 5, the remote system 160 can implement a mixed centralized and decentralized training technique. Although differences exist between these various techniques, each of these various techniques can be implemented using the all or aspects of the framework of the process flow depicted in FIG. 1A.

Generally, upon initiating a given round of decentralized learning of the global ML model, an update distribution engine 140 of the remote system 160 can transmit a version of the global ML model (or weights thereof) to the client device 150 and/or one or more of the additional client device(s) 170 as updated ML model(s) 108 and over one or more networks (e.g., any combination of local area networks (LANs), wide area networks (WANs), and/or any other type of network). In some implementations, the version of the global ML model that is transmitted to the client device 150 and/or one or more of the additional client device(s) 170 is the checkpoint version of the global ML model (e.g., as described with respect to FIG. 1B). In additional or alternative implementations, the version of the global ML model that is transmitted to the client device 150 and/or one or more of the additional client device(s) 170 is an averaged version of the global ML model (e.g., as described with respect to FIGS. 1C and 1D). The client device 150 and/or one or more of the additional client device(s) 170 can store the received version of the global ML model (or the weights thereof) in on-device ML model(s) database 154A as an on-device counterpart of the global ML model.

In some implementations (e.g., when the remote system 160 implements the static checkpoint averaging technique, the dynamic checkpoint averaging technique, and/or the mixed centralized and decentralized training technique), on-device machine learning (ML) engine 132A can process client data 101A, using the on-device ML model(s) stored in the on-device ML model(s) database 154A, to generate predicted output(s) 102. In these implementations, update engine 134A can generate a client update 103 based on the predicted output(s) 102. In some implementations, the update engine 134A can generate the client update 103 based on comparing the predicted output(s) 102 to ground truth output(s) 101B corresponding to the client data 101A using supervised learning techniques (e.g., in implementations where the ground truth output(s) 101B are available). In additional or alternative implementations, the update engine 134A can generate the client update 103 using self-supervised and/or unsupervised learning techniques (e.g., in implementations where the ground truth output(s) 101B are not available). The client device 150 can then transmit the client update 103 to a remote system 160 over one or more of the networks, and optionally without transmitting any of the client data 101A, the ground truth output(s) 101B, the predicted output(s) 102, and/or any other personally identifiable information. In various implementations, the client device 150 can transmit the client update 103 to the remote system 160 response to determining one or more conditions are satisfied (e.g., time of day, day of week, whether the client device 150 is being held, whether the client device 150 has a threshold state of charge, etc.).

In some implementations, the client update 103 (and other client updates described herein) may be a client gradient that is derived from a loss function used to train the ML model(s), such that the client gradient represents a value of that loss function (or a derivative thereof) obtained from comparison of the ground truth output(s) 101B to the predicted output(s) 102 (e.g., using supervised learning techniques). For example, when the ground truth output(s) 101B and the predicted output(s) 102 match, the update engine 134A can generate a zero gradient. Also, for example, when the ground truth output(s) 101B and the predicted output(s) 102 do not match, the update engine 134A can generate a non-zero gradient that is optionally dependent on the extent of the mismatching. The extent of the mismatching can be based on an extent of mismatching between deterministic comparisons of the ground truth output(s) 101B and the predicted output(s) 102. In additional or alternative implementations, the client update 103 (and other client updates described herein) may be a client gradient that is derived from a loss function used to train the ML model(s), such that the client gradient represents a value of that loss function (or a derivative thereof) determined based on the predicted output(s) 102 and without utilization of any ground truth output(s) 101B (e.g., using supervised or semi-supervised learning techniques).

In additional or alternative implementations, the client update 103 (and other client updates described herein) may be updated weights of the on-device ML model(s) stored in on-device ML model(s) database 154A. For example, in these implementations, the update engine 134A can cause weights of the on-device ML model(s) utilized to generate the predicted output(s) 102 to be updated based on the client gradient (e.g., generated using supervised learning techniques, or using supervised or semi-supervised learning techniques). Further, in these implementations, the updated weights of the on-device ML model(s) may be the client update 103, such that the updated weights of the on-device ML model(s) can be transmitted to the remote system 160 without transmitting any of the client data 101A, the ground truth output(s) 101B, the predicted output(s) 102, or the client gradient.

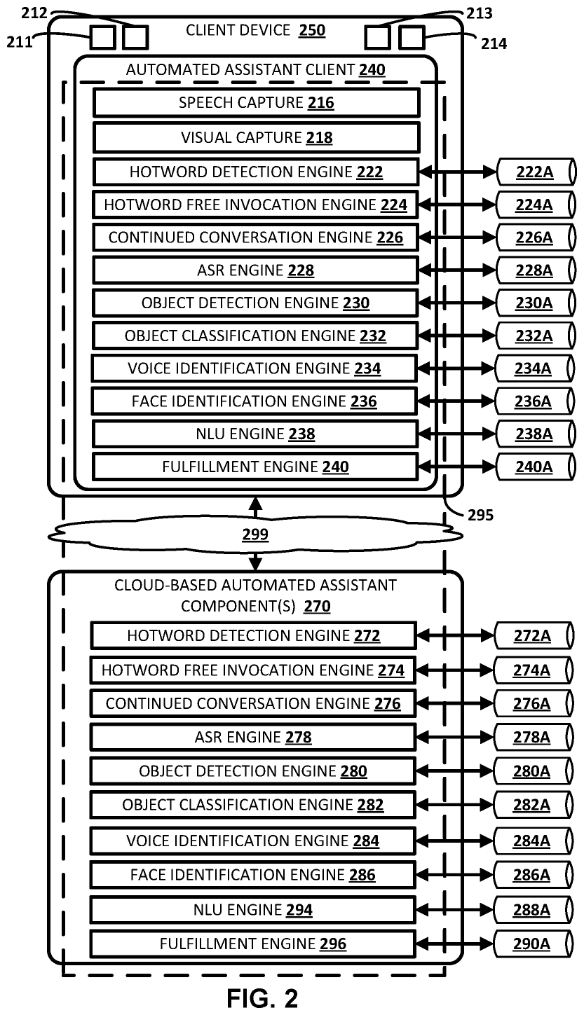

As described in more detail herein (e.g., with respect to FIG. 2), the client data 101A can be audio data generated by microphone(s) of the client device 150 and/or stored in on-device storage of the client device 150, textual data provided as input by a user of the client device 150 and/or stored in on-device storage of the client device 150, vision data generated by vision component(s) of the client device and/or stored in on-device storage of the client device 150, and/or any other data that is generated locally at the client device 150 or otherwise accessible to the client device 150. Notably, the client data 101A corresponds to access-restricted data, or data that is not publicly available and/or available to the remote system 160. Accordingly, and as also described in more detail herein (e.g., with respect to FIG. 2), the global ML model and the on-device counterparts there can include audio-based ML model(s) that are trained to process audio data, text-based ML model(s) that are trained to process the textual data, vision-based ML model(s) that are trained to process the vision data, and/or other ML model(s) that are trained to process the respective other data.

In some implementations (e.g., when the remote system 160 implements the mixed centralized and decentralized training technique), global ML engine 132A can process server data 104A, using global ML model(s) stored in global ML model(s) database 154B, to generate predicted output(s) 105. The server data 104A can be obtained from server data database 152B. The server data database 152B can include any data that is accessible by the remote system 160 including, but not limited to, public data repositories that include audio data, textual data, and/or vision data, and private data repositories. Further, the server data database 152B can include data that differs from client data accessible by the client device 150 and/or a plurality of additional client devices 170. For example, the server data database 152B can include audio data captured by near-field microphone(s) (e.g., similar to audio data captured by the client device 150) and audio data captured by far-field microphone(s) (e.g., audio data captured by other devices). As another example, the server data database 152B can include vision data captured by different vision components, such as RGB image data, RGB-D image data, CMYK image data, and/or other types of image data captured by various different vision components. Moreover, the remote system 160 can employ one or more techniques to the server data 104A to modify the server data 104A. These techniques can include filtering audio data to add or remove noise when the server data 104A is audio data, blurring images when the server data 104A is image data, and/or other techniques to manipulate the server data 104A. This allows the remote system 160 to better reflect client data generated by a plurality of different client devices and/or satisfy a need for a particular type of data (e.g., induce false positives or false negatives, ensure sufficient diversity of audio data as described herein, etc.).

In these implementations, update engine 134B can generate a remote update 106 based on the predicted output(s) 105. In some versions of these implementations, the update engine 134B can generate the remote update 106 based on comparing the predicted output(s) 105 to ground truth output(s) 104B corresponding to the server data 104A using supervised learning techniques (e.g., in implementations where the ground truth output(s) 104B are available). In additional or alternative implementations, the update engine 134B can generate the remote update 106 using self-supervised and/or unsupervised learning techniques (e.g., in implementations where the ground truth output(s) 101B are not available).

In some versions of these implementations, the remote system 160 can simulate client devices as “canary” users such that it appears the remote update 106 is being generated by an actual client device. The remote update 106 (and any additional remote updates) can be stored in update(s) database 136A (e.g., long-term memory and/or short-term memory, such as a buffer), and optionally along with the client update 103 received from the client device 150 and corresponding additional client update(s) 107 received from one or more of the plurality of additional client devices 170. The additional client update(s) 107 received from the plurality of additional client devices 170 can each be generated based on the same or similar technique as described above with respect to generating the client update 103, but on the basis of locally generated or provided client data at a respective one of the plurality of additional client devices 170.

As noted above, the updates 103, 106, and/or 107 can be stored in the update(s) database 136 (or other memory (e.g., a buffer)) as the updates 103, 106, and/or 107 are generated and/or received. In some implementations, the updates 103, 106, and/or 107 can indexed by type of update, from among a plurality of different types of updates, that is determined based on the corresponding on-device ML model(s) that processed the client data 101A and/or the corresponding global ML model(s) that processed the server data 104A. The plurality of disparate types of updates can be defined with varying degrees of granularity. For example, the types of updates can be particularly defined, for example, hotword updates generated based on processing audio data using hotword model(s), ASR updates generated based on processing audio data, voice activity detection (VAD) updates generated based on processing audio data using VAD model(s), continued conversation updates generated based on processing audio data using continued conversation model(s), voice identification updates generated based on processing audio data using voice identification model(s), face identification updates generated based on processing image data using face identification model(s), hotword free updates generated based on processing image data using hotword free model(s), object detection updates generated based on processing image data using object detection model(s), text-to-speech (TTS) updates generated based on processing textual segments using TTS model(s), and/or any other updates that may be generated based on processing data using any other ML model. Notably, a given one of the updates 103, 106, and/or 107 can belong one to one of the multiple different types of updates. Accordingly, as another example, the types of updates can be more generally defined as, for example, audio-based updates generated based on processing audio data using one or more audio-based ML models, vision-based updates generated based on processing image data using one or more image-based ML models, or text-based updates generated based on processing textual segments using text-based ML models.

Remote training engine 136 can utilize the client update 103, the remote update 106, and/or the additional update(s) 107 to update the weights of the global ML model(s) stored in the global ML model(s) database 154B. However, whether the remote training engine 136 utilizes the client update 103, the remote update 106, and/or the additional update(s) 107 to update the weights of the global ML model(s), and when the remote training engine 136 utilizes the client update 103, the remote update 106, and/or the additional update(s) 107 to update the weights of the global ML model(s) can vary based on the particular checkpoint averaging technique being implemented by the remote system 160.

Referring specifically to FIG. 1B, assume that the remote system 160 is implementing the static checkpoint averaging technique. In implementing the static checkpoint averaging technique, further assume that the remote system 160 has initially trained a global ML model. The ML checkpoint engine 138 can cause the initially trained global ML model to be stored in remote storage of the remote system 160 (e.g., the global ML model(s) database 154B) as a checkpoint version of the global ML model as indicated by cₜ 180B in FIG. 1B. During a first round of decentralized learning of the global ML model over time t, the update distribution engine 140 can provide the checkpoint version of the global ML model to a plurality of client devices to cause each of the plurality of client devices as indicated by wₜ 181B in FIG. 1B to generate a corresponding client update for the global ML model. Accordingly, over time t, each of the plurality of client devices can transmit the corresponding client updates back to the remote system 160. This enables the remote system 160 to generate a decentralized version of the global ML model based on the corresponding client updates received over time t and based on the checkpoint version of the global ML model. Further, the decentralized version of the global ML model can be stored in the remote storage of the remote system 160 (e.g., the global ML model(s) database 154B). In implementations where the corresponding client updates include corresponding gradients, global weights and/or other global parameters of the checkpoint version of the global ML model can be updated based on the corresponding gradients to generate the decentralized version of the global ML model. In implementations where the corresponding client updates include corresponding weights, the global weights of the checkpoint version of the global ML model can be replaced with an average of the corresponding weights to generate the decentralized version of the global ML model.

However, in these implementations, the remote system 160 can further generate an averaged version of the global ML model as indicated by aₜ 182B. The averaged version of the global ML model can be an average of the checkpoint version of the global ML model and the decentralized version of the global ML model. Further, the averaged version of the global ML model can be stored in the remote storage of the remote system 160 (e.g., the global ML model(s) database 154B). In some implementations, the average of the checkpoint version of the global ML model and the decentralized version of the global ML model can be a weighted average thereof. For example, decentralized weights of the decentralized version of the global ML model can be assigned a first weight (e.g., 0.75, 0.25, or another weight) and checkpoint weights of the checkpoint version of the global ML model can be assigned a second weight (e.g., 0.25, 0.75, or another weight), and these weights can be averaged to generate averaged weights of the averaged version of the global ML model.

Notably, the remote system 160 can continue causing additional rounds of decentralized learning of the global ML model to be performed and using the static checkpoint averaging technique. In causing the additional rounds of decentralized learning of the global ML model to be performed, the remote system 160 can continue causing each of a corresponding plurality of client devices as indicated by wₜ₊₁ 183B, wₜ₊₂ 185B, wₜ₊₃ 187B, and so on in FIG. 1B to generate a corresponding client update for the global ML model. The remote system 160 can continue updating the decentralized version of the global ML model. Further, the remote system 160 can continue generating additional averaged versions of the global ML model based on the corresponding client updates for the global ML model received during each of the additional rounds of decentralized learning of the global ML model as indicated by aₜ₊₁ 184B, aₜ₊₂ 186B, and so on in FIG. 1B. Moreover, the remote system 160 can continue storing each of the additional averaged versions of the global ML model in the remote storage of the remote system 160 (e.g., the global ML model(s) database 154B).

In these implementations, and in response to determining one or more conditions are satisfied, the remote system 160 can cause one of the averaged versions of the global ML model to be deployed as the global ML model. For example, the remote system 160 can evaluate each of the averaged versions of the global ML model to determine corresponding performance measures thereof, and can select one of the averaged versions of the global ML model to be deployed as the global ML model based on the corresponding performance measures. The one or more conditions can include, for example, whether performance of any the averaged version of the global ML model satisfies a performance threshold, whether a threshold quantity of averaged versions of the global ML model have been generated, whether a threshold quantity of rounds of decentralized learning of the global ML model have been performed, a time of day, a day of week, and/or other conditions. By utilizing the static checkpoint averaging technique, the remote system 160 can ensure that the averaged version of the global ML model that is deployed as the global ML model is more robust to catastrophic forgetting. Put another way, by utilizing the static checkpoint averaging technique, the remote system 160 can ensure that the global ML model that is deployed is not over fit to client data and still retains information learned in initially training the global ML model based on server data.

Referring specifically to FIG. 1C, assume that the remote system 160 is implementing the dynamic checkpoint averaging technique. In implementing the dynamic checkpoint averaging technique, further assume that the remote system 160 has initially trained a global ML model. The ML checkpoint engine 138 can cause the initially trained global ML model to be stored in remote storage of the remote system 160 (e.g., the global ML model(s) database 154B) as a checkpoint version of the global ML model as indicated by cₜ 180C in FIG. 1C. Similar to the static checkpoint averaging technique, the remote system 160 can continue updating the decentralized version of the global ML model. However, and in contrast with the static checkpoint averaging technique of FIG. 1B, the remote system 160 may only generate the averaged version of the global ML model after N rounds of decentralized learning, where N is an integer value that is one or greater than one (e.g., 5 rounds, 10 rounds, and/or other integer values greater than one) that is configurable.

For example, during a first round of decentralized learning of the global ML model over time t, the update distribution engine 140 can provide the checkpoint version of the global ML model to a plurality of client devices to cause each of the plurality of client devices as indicated by wₜ 181C in FIG. 1C to generate a corresponding client update for the global ML model. Accordingly, over time t, each of the plurality of client devices can transmit the corresponding client updates back to the remote system 160. This enables the remote system 160 to generate a decentralized version of the global ML model based on the corresponding client updates received over time t and based on the checkpoint version of the global ML model. Further, the decentralized version of the global ML model can be stored in the remote storage of the remote system 160 (e.g., the global ML model(s) database 154B). Notably, the remote system 160 can continue causing additional rounds of decentralized learning of the global ML model to be performed and continue updating the decentralized version of the global ML model until the Nth round of decentralized learning has been completed.

Further, and in response to the Nth round of decentralized learning being completed, the remote system 160 can further generate an averaged version of the global ML model as indicated by a_{t+N} 182C. Similarly, the averaged version of the global ML model can be an average of the checkpoint version of the global ML model and the decentralized version of the global ML model that was updated after the Nth round of decentralized learning. Further, the averaged version of the global ML model can be stored in the remote storage of the remote system 160 (e.g., the global ML model(s) database 154B). In some implementations, the average of the checkpoint version of the global ML model and the decentralized version of the global ML model can be a weighted average thereof. For example, decentralized weights of the decentralized version of the global ML model can be assigned a first weight (e.g., 0.75, 0.25, or another weight) and checkpoint weights of the checkpoint version of the global ML model can be assigned a second weight (e.g., 0.25, 0.75, or another weight), and these weights can be averaged to generate averaged weights of the averaged version of the global ML model.

Notably, the remote system 160 can continue causing additional N rounds of decentralized learning of the global ML model to be performed and using the dynamic checkpoint averaging technique. In causing the additional rounds of decentralized learning of the global ML model to be performed, the remote system 160 can continue causing each of a corresponding plurality of client devices as indicated by w_{t+N} 183C, w_{t+2N} 185C, w_{t+3N} 187C, and so on in FIG. 1C to generate corresponding client updates for the global ML model. The remote system 160 can continue updating the decentralized version of the global ML model. Notably, and in contrast with the static checkpoint averaging technique, in initiating a subsequent N rounds of decentralized learning of the global ML model, the update distribution engine 140 can cause the averaged version of the global ML model generated based on the prior N rounds of decentralized learning to be distributed to each of the corresponding plurality of client devices. Further, the remote system 160 can continue generating additional averaged versions of the global ML model based on the corresponding client updates for the global ML model received subsequent to the N additional rounds of decentralized learning of the global ML model as indicated by a_{t+2N} 184C, a_{t+3N} 186C, and so on in FIG. 1C. Moreover, the remote system 160 can continue storing each of the additional averaged versions of the global ML model in the remote storage of the remote system 160 (e.g., the global ML model(s) database 154B).

In these implementations, and in response to determining one or more conditions are satisfied, the remote system 160 can cause one of the averaged versions of the global ML model to be deployed as the global ML model. For example, the remote system 160 can evaluate each of the averaged versions of the global ML model to determine corresponding performance measures thereof, and can select one of the averaged versions of the global ML model to be deployed as the global ML model based on the corresponding performance measures. The one or more conditions can include, for example, whether performance of any the averaged version of the global ML model satisfies a performance threshold, whether a threshold quantity of averaged versions of the global ML model have been generated, whether a threshold quantity of rounds of decentralized learning of the global ML model have been performed, a time of day, a day of week, and/or other conditions. By utilizing the dynamic checkpoint averaging technique, the remote system 160 can ensure that the averaged version of the global ML model that is deployed as the global ML model is more robust to catastrophic forgetting. Put another way, by utilizing the dynamic checkpoint averaging technique, the remote system 160 can additionally, or alternatively, ensure that the global ML model that is deployed is not over fit to client data and still retains information learned in initially training the global ML model based on server data.

Referring specifically to FIG. 1D, assume that the remote system 160 is implementing the mixed centralized and decentralized training technique. In implementing the mixed centralized and decentralized training technique, further assume that the remote system 160 has initially trained a global ML model. The ML checkpoint engine 138 can cause the initially trained global ML model to be stored in remote storage of the remote system (e.g., the global ML model(s) database 154B) as a checkpoint version of the global ML model as indicated by cₜ 180D in FIG. 1D. Similar to the dynamic checkpoint averaging technique of FIG. 1C, the remote system 160 can continue updating the decentralized version of the global ML model. However, and in contrast with the dynamic checkpoint averaging technique of FIG. 1C, the remote system 160 can also perform M rounds of centralized learning of the global ML model and in parallel with the N rounds of decentralized learning of the global ML model. Further, and in contrast with the dynamic checkpoint averaging technique of FIG. 1C, the remote system 160 may only generate the averaged version of the global ML model after the N rounds of decentralized learning and after the M rounds of centralized learning, where M is an integer value that is one or greater than one (e.g., 5 rounds, 10 rounds, and/or other integer values greater than one) that is configurable and that can differ from N.

For example, during a first round of decentralized learning of the global ML model over time t, the update distribution engine 140 can provide the checkpoint version of the global ML model to a plurality of client devices to cause each of the plurality of client devices as indicated by wₜ 181D in FIG. 1D to generate a corresponding client update for the global ML model. Accordingly, over time t, each of the plurality of client devices can transmit the corresponding client updates back to the remote system 160. This enables the remote system 160 to generate a decentralized version of the global ML model based on the corresponding client updates received over time t and based on the checkpoint version of the global ML model. Further, the decentralized version of the global ML model can be stored in the remote storage of the remote system 160 (e.g., the global ML model(s) database 154B). Notably, the remote system 160 can continue causing additional rounds of decentralized learning of the global ML model to be performed and continue updating the decentralized version of the global ML model until the Nth round of decentralized learning has been completed.

In parallel, during a first round of centralized learning of the global ML model over time t, the remote system 160 can obtain additional server data (e.g., that is in addition to the server data utilized to initially train the global ML model) that is accessible by the remote system 160, and generate a remote update for the global ML model based on processing the additional server data. Accordingly, over time t, the remote system 160 can continue to generate the remote updates. This enables the remote system 160 to generate a centralized version of the global ML model based on the corresponding remote updates generated over time t and based on the checkpoint version of the global ML model. Further, the centralized version of the global ML model can be stored in the remote storage of the remote system 160 (e.g., the global ML model(s) database 154B). Notably, the remote system 160 can continue causing additional rounds of centralized learning of the global ML model to be performed and continue updating the centralized version of the global ML model until the Mth round of centralized learning has been completed.

Further, in response to the Nth round of decentralized learning being completed and in response to the Mth round of centralized learning being completed, the remote system 160 can further generate an averaged version of the global ML model as indicated by a_{T} 182D. The averaged version of the global ML model can be an average of the decentralized version of the global ML model after the N rounds of decentralized learning and the centralized version of the global ML model after the M rounds of centralized learning. Further, the averaged version of the global ML model can be stored in the remote storage of the remote system 160 (e.g., the global ML model(s) database 154B). In some implementations, the average of after the decentralized version of the global ML model after the N rounds of decentralized learning and the centralized version of the global ML model after the M rounds of centralized learning can be a weighted average thereof. For example, decentralized weights of the decentralized version of the global ML model can be assigned a first weight (e.g., 0.75, 0.5, 0.25, or another weight) and centralized weights of the centralized version of the global ML model can be assigned a second weight (e.g., 0.25, 0.5 0.75, or another weight), and these weights can be averaged to generate averaged weights of the averaged version of the global ML model.

Notably, the remote system 160 can continue causing additional N rounds of decentralized learning of the global ML model and additional M rounds of centralized learning of the global ML model to be performed and using the mixed centralized and decentralized training technique. In causing the additional rounds of decentralized learning of the global ML model to be performed, the remote system 160 can continue causing each of a corresponding plurality of client devices as indicated by w_{t+N} 184D, w_{t+2N} 187D, w_{t+3N} 190D, and so on in FIG. 1D to generate corresponding client updates for the global ML model. The remote system 160 can continue updating the decentralized version of the global ML model. Further, in causing the additional rounds of centralized learning of the global ML model to be performed, the remote system 160 can continue generating remote updates as indicated by c_{t+M} 183D, C_{t+2M} 186D, c_{t+3M} 189D, and so on in FIG. 1D. The remote system 160 can continue updating the centralized version of the global ML model.

Notably, and in contrast with the static checkpoint averaging technique, in initiating a subsequent N rounds of decentralized learning of the global ML model and a subsequent M rounds of centralized learning of the global ML model, the update distribution engine 140 can cause the averaged version of the global ML model generated based on the prior N rounds of decentralized learning and the prior M rounds of centralized learning to be distributed to each of the corresponding plurality of client devices and subsequently utilized by the remote system 160. Further, the remote system 160 can continue updating the averaged version of the global ML model based on the corresponding client updates for the global ML model received subsequent to the N additional rounds of decentralized learning of the global ML model and subsequent to the M additional rounds of centralized learning of the global ML model as indicated by a_{T} 185D, a_{T} 188D, and so on in FIG. 1D.

In these implementations, and in response to determining one or more conditions are satisfied, the remote system 160 can cause the averaged versions of the global ML model to be deployed as the global ML model. The one or more conditions can include, for example, whether performance of any the averaged version of the global ML model satisfies a performance threshold, whether a threshold quantity of averaged versions of the global ML model have been generated, whether a threshold quantity of rounds of decentralized learning of the global ML model have been performed, a time of day, a day of week, and/or other conditions. By utilizing the mixed centralized and decentralized training technique, the remote system 160 can ensure that the averaged version of the global ML model that is deployed as the global ML model is more robust to catastrophic forgetting. Put another way, by utilizing the mixed centralized and decentralized training technique, the remote system 160 can additionally, or alternatively, ensure that the global ML model that is deployed is not over fit to client data and still retains information learned in initially training the global ML model based on server data.

Turning now to FIG. 2, a client device 250 is illustrated in an implementation where various on-device ML engines are included as part of (or in communication with) an automated assistant client 240 is depicted. The respective ML models are also illustrated interfacing with the various on-device ML engines. Other components of the client device 250 are not illustrated in FIG. 2 for simplicity. FIG. 2 illustrates one example of how the various on-device ML engines of and their respective ML models can be utilized by the automated assistant client 240 in performing various actions.

The client device 250 in FIG. 2 is illustrated with one or more microphones 211, one or more speakers 212, one or more vision components 213, and display(s) 214 (e.g., a touch-sensitive display). The client device 250 may further include pressure sensor(s), proximity sensor(s), accelerometer(s), magnetometer(s), and/or other sensor(s) that are used to generate other sensor data that is in addition to audio data captured by the one or more microphones 211. The client device 250 at least selectively executes the automated assistant client 240. The automated assistant client 240 includes, in the example of FIG. 2, hotword detection engine 222, hotword free invocation engine 224, continued conversation engine 226, ASR engine 228, object detection engine 230, object classification engine 232, voice identification engine 234, and face identification engine 236. The automated assistant client 240 further includes speech capture engine 216, and visual capture engine 218. It should be understood that the ML engines and ML models depicted in FIG. 2 are provided for the sake of example, and are not meant to be limiting. For example, the automated assistant client 240 can further include additional and/or alternative engines, such as a text-to-speech (TTS) engine and a respective TTS model, a voice activity detection (VAD) engine and a respective VAD model, an endpoint detector engine and a respective endpoint detector model, a lip movement engine and a respective lip movement model, and/or other engine(s) along with associated machine learning model(s). Moreover, it should be understood that one or more of the engines and/or models described herein can be combined, such that a single engine and/or model can perform the functions of multiple engines and/or models described herein.

One or more cloud-based automated assistant components 270 can optionally be implemented on one or more computing systems (collectively referred to as a “cloud” computing system) that are communicatively coupled to client device 250 via one or more of the networks described with respect to FIGS. 1A-1D as indicated generally by 299. The cloud-based automated assistant components 270 can be implemented, for example, via a cluster of high-performance servers. In various implementations, an instance of an automated assistant client 240, by way of its interactions with one or more cloud-based automated assistant components 270, may form what appears to be, from a user's perspective, a logical instance of an automated assistant as indicated generally by 295 with which the user may engage in a human-to-computer interactions (e.g., spoken interactions, gesture-based interactions, and/or touch-based interactions).

The client device 250 can be, for example: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television (or a standard television equipped with a networked dongle with automated assistant capabilities), and/or a wearable apparatus of the user that includes a computing device (e.g., a watch of the user having a computing device, glasses of the user having a computing device, a virtual or augmented reality computing device). Additional and/or alternative client devices may be provided.

The one or more vision components 213 can take various forms, such as monographic cameras, stereographic cameras, a LIDAR component (or other laser-based component(s)), a radar component, etc. The one or more vision components 213 may be used, e.g., by the visual capture engine 218, to capture image data corresponding to vision frames (e.g., image frames, laser-based vision frames) of an environment in which the client device 250 is deployed. In some implementations, such vision frame(s) can be utilized to determine whether a user is present near the client device 250 and/or a distance of the user (e.g., the user's face) relative to the client device 250. Such determination(s) can be utilized, for example, in determining whether to activate the various on-device machine learning engines depicted in FIG. 2, and/or other engine(s). Further, the speech capture engine 218 can be configured to capture a user's spoken utterance(s) and/or other audio data captured via the one or more of the microphones 211.

As described herein, such audio data, vision data, and textual data (also referred to as client data) can be processed by the various engines depicted in FIG. 2 to make predictions at the client device 250 using deployed ML models (that include the updated global ML models and/or the updated weights thereof) generated in the manner described above with respect to FIGS. 1A-1D.

As some non-limiting example, the hotword detection engine 222 can utilize a hotword detection model 222A to predict whether audio data includes one or more particular words or phrases to invoke the automated assistant 295 (e.g., “Ok Google”, “Hey Google”, “What is the weather Google?”, etc.) or certain functions of the automated assistant 295; the hotword free invocation engine 224 can utilize a hotword free invocation model 224A to predict whether vision data includes a gesture or signal to invoke the automated assistant 295 (e.g., based on a gaze of the user and optionally further based on mouth movement of the user); the continued conversation engine 226 can utilize a continued conversation model 226A to predict whether further audio data is directed to the automated assistant 295 (e.g., or directed to an additional user in the environment of the client device 250); the ASR engine 228 can utilize an ASR model 228A to generate recognized text, or predict phoneme(s) and/or token(s) that correspond to audio data detected at the client device 250 and generate the recognized text based on the phoneme(s) and/or token(s); the object detection engine 230 can utilize an object detection model 230A to predict object location(s) included in vision data of an image or video captured at the client device 250; the object classification engine 232 can utilize an object classification model 232A to predict object classification(s) of object(s) included in vision data of an image or video captured at the client device 250; the voice identification engine 234 can utilize a voice identification model 234 to predict whether audio data captures a spoken utterance of one or more users of the client device 250 (e.g., by generating a speaker embedding, or other representation, that can be compared to a corresponding actual embeddings for one or more of the user of the client device 250); and the face identification engine 236 can utilize a face identification model to predict whether vision data of an image or video captures one or more of the users in an environment of the client device 250 (e.g., by generating an image embedding, or other representation, that can be compared to a corresponding image embeddings for one or more of the user of the client device 250).

In some implementations, the client device 250 may further include natural language understanding (NLU) engine 238 and fulfillment engine 240. The NLU engine 238 may perform on-device natural language understanding, utilizing NLU model 238A, on recognized text, predicted phoneme(s), and/or predicted token(s) generated by the ASR engine 228 to generate NLU data. The NLU data can include, for example, intent(s) that correspond to the spoken utterance and optionally slot value(s) for parameter(s) for the intent(s). Further, the fulfillment engine 240 can generate fulfillment data utilizing on-device fulfillment model 240A, and based on processing the NLU data. This fulfillment data can define local and/or remote responses (e.g., answers) to spoken utterances provided by a user of the client device 250, interaction(s) to perform with locally installed application(s) based on the spoken utterances, command(s) to transmit to Internet-of-things (IoT) device(s) (directly or via corresponding remote system(s)) based on the spoken utterance, and/or other resolution action(s) to perform based on the spoken utterance. The fulfillment data is then provided for local and/or remote performance/execution of the determined action(s) to resolve the spoken utterance. Execution can include, for example, rendering local and/or remote responses (e.g., visually and/or audibly rendering (optionally utilizing an on-device TTS module)), interacting with locally installed applications, transmitting command(s) to IoT device(s), and/or other action(s). In other implementations, the NLU engine 234 and the fulfillment engine 240 may be omitted, and the ASR engine 228 can generate the fulfillment data directly based on the audio data. For example, assume the ASR engine 228 processes, using the ASR model 228A, a spoken utterance of “turn on the lights.” In this example, the ASR engine 228 can generate a semantic output that is then transmitted to a software application associated with the lights and/or directly to the lights that indicates that they should be turned on.

Notably, the cloud-based automated assistant component(s) 270 include cloud-based counterparts to the engines and models described herein with respect to FIG. 2. However, in various implementations, these engines and models may not be invoked since the engines and models may be transmitted directly to the client device 250 and executed locally at the client device 250 as described above with respect to FIGS. 1A-1D. Nonetheless, a remote execution module can also optionally be included that performs remote execution based on local or remotely generated NLU data and/or fulfillment data. Additional and/or alternative remote engines can be included. As described herein, in various implementations on-device speech processing, on-device image processing, on-device NLU, on-device fulfillment, and/or on-device execution can be prioritized at least due to the latency and/or network usage reductions they provide when resolving a spoken utterance (due to no client-server roundtrip(s) being needed to resolve the spoken utterance). However, one or more cloud-based automated assistant component(s) 280 can be utilized at least selectively. For example, such component(s) can be utilized in parallel with on-device component(s) and output from such component(s) utilized when local component(s) fail. For example, if any of the on-device engines and/or models fail (e.g., due to relatively limited resources of client device 150), then the more robust resources of the cloud may be utilized.

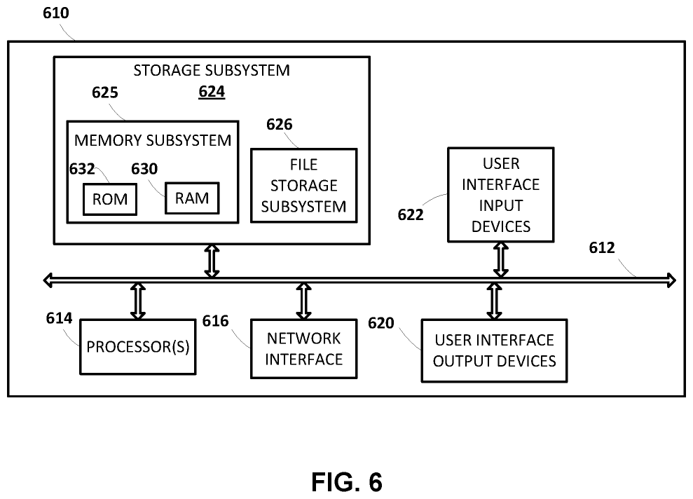

Turning now to FIG. 3, a flowchart illustrating an example method 300 of a static checkpoint averaging technique utilized in decentralized learning of a global machine learning (ML) model is depicted. For convenience, the operations of the method 300 are described with reference to a system that performs the operations. The system of method 300 includes one or more processors and/or other component(s) of a computing device (e.g., client device 150 of FIG. 1, remote system 160 of FIG. 1, client device 250 of FIG. 2, cloud-based automated assistant component(s) 270 of FIG. 2, computing device 610 of FIG. 6, and/or other client devices). Moreover, while operations of the method 300 are shown in a particular order, this is not meant to be limiting. One or more operations may be reordered, omitted, or added.

At block 352, the system trains, based on server data that is accessible by a remote system, a global ML model. For example, the system can obtain server data that is accessible by the remote system, and train the global ML model based on the server data. In various implementations, the server data obtained by the system to train the global ML model can be based on a type of the global ML model. For example, if the global ML model is an audio-based global ML model, then the system can obtain audio data to train the global ML model. As another example, if the global ML model is a vision-based global ML model, then the system can obtain vision data to train the global ML model. As yet another example, if the global ML model is a text-based global ML model, then the system can obtain textual data to train the global ML model.

At block 354, the system determines whether to initiate a given round of decentralized learning of the global ML model. The system can determine whether to initiate the given round of decentralized learning of the global ML model based on, for example, whether the system has finished training the global ML model at block 354, whether the system has trained the global ML model at block 354 based on a threshold quantity of server data, whether the system has determined the global ML model trained at block 354 has a achieved a threshold level of performance, and/or based on other factors.

If, at an iteration of block 354, the system determines not to initiate a given round of decentralized learning of the global ML model, then the system continues monitoring for whether to initiate a given round of decentralized learning of the global ML model at block 354. In various implementations, the system can continue training the global ML model at block 352 until it is determined to initiate a given round of decentralized learning of the global ML model at block 354. If, at an iteration of block 354, the system determines to initiate a given round of decentralized learning of the global ML model, then the system proceeds to block 356.

At block 356, the system receives, from a plurality of corresponding client devices, a plurality of client updates for the global ML model (e.g., as described with respect to FIGS. 1A and 1B). At block 358, the system identifies a checkpoint version of the global ML model that is stored remotely at the remote system (e.g., as described with respect to FIGS. 1A and 1B). At block 360, the system generates, based on the checkpoint version of the global ML model and based on the plurality of client updates received from the plurality of corresponding client updates, a decentralized version of the global ML model (e.g., as described with respect to FIGS. 1A and 1B). At block 362, the system generates, based on the checkpoint version of the global ML model and based on the decentralized version of the global ML model, an averaged version of the global ML model (e.g., as described with respect to FIGS. 1A and 1B). Although the static checkpoint averaging technique of the method 300 of FIG. 3 is described with respect to generating the averaged version of the global ML model subsequent to each round of decentralized learning, it should be understood that the averaged version of the global ML model can be generated every N rounds similar to the dynamic checkpoint averaging technique.

At block 364, the system determines whether one or more conditions for causing the global ML model to be deployed are satisfied (e.g., as described with respect to FIGS. 1A and 1B). If, at an iteration of block 364, the system determines that the one or more conditions for causing the global ML model to be deployed are not satisfied, then the system returns to block 354 to initiate an additional round of decentralized learning of the global ML model. During the additional round of decentralized learning, the system may omit an additional iteration of block 358 since the checkpoint version of the global ML model has already been identified, and can update the decentralized version of the global ML model at an additional iteration of block 360 rather than generating a new decentralized version of the global ML model.

If, at an iteration of block 364, the system determines that the one or more conditions for causing the global ML model to be deployed are satisfied, then the system proceeds to block 366. At block 366, the system causes the averaged version of the global ML model or an additional averaged version of the global ML model to be deployed as the global ML model. As described with respect to FIGS. 1A and 1B, the system can evaluate all of the averaged versions of the global ML model that have been generated, and select one of the averaged versions of the global ML model to be deployed based on the evaluation of all of the averaged versions of the global ML model.

Turning now to FIG. 4, a flowchart illustrating an example method 400 of a dynamic checkpoint averaging technique utilized in decentralized learning of a global machine learning (ML) model is depicted. For convenience, the operations of the method 400 are described with reference to a system that performs the operations. The system of method 400 includes one or more processors and/or other component(s) of a computing device (e.g., client device 150 of FIG. 1, remote system 160 of FIG. 1, client device 250 of FIG. 2, cloud-based automated assistant component(s) 270 of FIG. 2, computing device 610 of FIG. 6, and/or other client devices). Moreover, while operations of the method 400 are shown in a particular order, this is not meant to be limiting. One or more operations may be reordered, omitted, or added.

At block 452, the system trains, based on server data that is accessible by a remote system, a global ML model. The system can train the global ML model in the same or similar manner described above with respect to block 352 of the method 300 of FIG. 3.

At block 454, the system determines whether to initiate N rounds of decentralized learning of the global ML model. The system can determine whether to initiate N rounds of decentralized learning of the global ML model in the same or similar manner described above with respect to block 354 of the method 300 of FIG. 3. However, it should be noted that the system is determining whether to initiate N rounds where N is an integer that is one or greater than one and is configurable. If, at an iteration of block 454, the system determines not to initiate N rounds of decentralized learning of the global ML model, then the system continues monitoring for whether to initiate N rounds of decentralized learning of the global ML model at block 454. In various implementations, the system can continue training the global ML model at block 452 until it is determined to initiate N rounds of decentralized learning of the global ML model at block 454. If, at an iteration of block 454, the system determines to initiate N rounds of decentralized learning of the global ML model, then the system proceeds to block 456.

At block 456, the system receives, from a plurality of corresponding client devices, a plurality of client updates for the global ML model (e.g., as described with respect to FIGS. 1A and 1C). At block 458, the system identifies a checkpoint version of the global ML model that is stored remotely at the remote system (e.g., as described with respect to FIGS. 1A and 1C). At block 460, the system generates, based on the checkpoint version of the global ML model and based on the plurality of client updates received from the plurality of corresponding client updates, a decentralized version of the global ML model (e.g., as described with respect to FIGS. 1A and 1C).

At block 462, the system determines whether the N rounds of decentralized learning have been completed. If, at an iteration of block 462, the system determines that the N rounds of decentralized learning have not been completed, then the system returns to block 456. During the additional round of decentralized learning, the system may omit an additional iteration of block 458 since the checkpoint version of the global ML model has already been identified, and can update the decentralized version of the global ML model at an additional iteration of block 460 rather than generating a new decentralized version of the global ML model. If, at an iteration of block 462, the system determines that the N rounds of decentralized learning have been completed, then the system proceeds to block 464.

At block 464, the system generates, based on the checkpoint version of the global ML model and based on the decentralized version of the global ML model after the N rounds, an averaged version of the global ML model (e.g., as described with respect to FIGS. 1A and 1C). At block 466, the system determines whether one or more conditions for causing the global ML model to be deployed are satisfied (e.g., as described with respect to FIGS. 1A and 1C). If, at an iteration of block 466, the system determines that the one or more conditions for causing the global ML model to be deployed are not satisfied, then the system returns to block 454 to initiate an additional N rounds of decentralized learning of the global ML model. Notably, for the additional N rounds of decentralized learning, the system can cause the averaged version of the global ML model to be distributed to any client devices participating in the decentralized learning of the global ML model.

If, at an iteration of block 466, the system determines that the one or more conditions for causing the global ML model to be deployed are satisfied, then the system proceeds to block 468. At block 468, the system causes the averaged version of the global ML model or an additional averaged version of the global ML model to be deployed as the global ML model. As described with respect to FIGS. 1A and 1C, the system can evaluate all of the averaged versions of the global ML model that have been generated, and select one of the averaged versions of the global ML model to be deployed based on the evaluation of all of the averaged versions of the global ML model.

Turning now to FIG. 5, a flowchart illustrating an example method 500 of a mixed centralized and decentralized training technique utilized in decentralized learning of a global machine learning (ML) model is depicted. For convenience, the operations of the method 500 are described with reference to a system that performs the operations. The system of method 500 includes one or more processors and/or other component(s) of a computing device (e.g., client device 150 of FIG. 1, remote system 160 of FIG. 1, client device 250 of FIG. 2, cloud-based automated assistant component(s) 270 of FIG. 2, computing device 610 of FIG. 6, and/or other client devices). Moreover, while operations of the method 500 are shown in a particular order, this is not meant to be limiting. One or more operations may be reordered, omitted, or added.

At block 552, the system trains, based on server data that is accessible by a remote system, a global ML model. The system can train the global ML model in the same or similar manner described above with respect to block 352 of the method 300 of FIG. 3.

At block 554, the system determines whether to initiate N rounds of decentralized learning of the global ML model. The system can determine whether to initiate N rounds of decentralized learning of the global ML model in the same or similar manner described above with respect to block 354 of the method 300 of FIG. 3. However, it should be noted that the system is determining whether to initiate N rounds where N is an integer that is one or greater than one and is configurable. If, at an iteration of block 554, the system determines not to initiate N rounds of decentralized learning of the global ML model, then the system continues monitoring for whether to initiate N rounds of decentralized learning of the global ML model at block 554. In various implementations, the system can continue training the global ML model at block 552 until it is determined to initiate N rounds of decentralized learning of the global ML model at block 554. If, at an iteration of block 554, the system determines to initiate N rounds of decentralized learning of the global ML model, then the system proceeds to block 556.

At block 556, the system receives, from a plurality of corresponding client devices, a plurality of client updates for the global ML model (e.g., as described with respect to FIGS. 1A and 1D). At block 558, the system identifies a checkpoint version of the global ML model that is stored remotely at the remote system (e.g., as described with respect to FIGS. 1A and 1D). At block 560, the system generates, based on the checkpoint version of the global ML model and based on the plurality of client updates received from the plurality of corresponding client updates, a decentralized version of the global ML model (e.g., as described with respect to FIGS. 1A and 1D).

At block 562, the system determines whether the N rounds of decentralized learning have been completed. If, at an iteration of block 562, the system determines that the N rounds of decentralized learning have not been completed, then the system returns to block 556. During the additional round of decentralized learning, the system may omit an additional iteration of block 558 since the checkpoint version of the global ML model has already been identified, and can update the decentralized version of the global ML model at an additional iteration of block 560 rather than generating a new decentralized version of the global ML model. If, at an iteration of block 562, the system determines that the N rounds of decentralized learning have been completed, then the system proceeds to block 574.

Notably, while the system determines whether to initiate N rounds of decentralized learning of the global ML model at block 554, the system, in parallel, determines whether to initiate M rounds of centralized learning of the global ML model at block 564. The system can determine whether to initiate M rounds of centralized learning of the global ML model in the same or similar manner described above with respect to block 554 and the N rounds of decentralized learning. Put another way, the system can determine to initiate the N rounds of decentralized learning and the M rounds of centralized learning at or approximately at the same time. If, at an iteration of block 564, the system determines not to initiate M rounds of centralized learning of the global ML model, then the system continues monitoring for whether to initiate M rounds of centralized learning of the global ML model at block 564. In various implementations, the system can continue training the global ML model at block 552 until it is determined to initiate M rounds of centralized learning of the global ML model at block 564. If, at an iteration of block 564, the system determines to initiate M rounds of centralized learning of the global ML model, then the system proceeds to block 566.

At block 566, the system identifies a checkpoint version of the global ML model that is stored remotely at the remote system (e.g., as described with respect to FIGS. 1A and 1D). At block 568, the system generates a remote update for the global ML model (e.g., as described with respect to FIGS. 1A and 1D). At block 570, the system generates, based on the checkpoint version of the global ML model and based on the remote update, a centralized version of the global ML model (e.g., as described with respect to FIGS. 1A and 1D).

At block 572, the system determines whether the M rounds of centralized learning have been completed. If, at an iteration of block 572, the system determines that the M rounds of centralized learning have not been completed, then the system returns to block 566. During the additional round of centralized learning, the system may omit an additional iteration of block 566 since the checkpoint version of the global ML model has already been identified, and can update the centralized version of the global ML model at an additional iteration of block 570 rather than generating a new decentralized version of the global ML model. If, at an iteration of block 572, the system determines that the M rounds of centralized learning have been completed, then the system proceeds to block 574.

At block 574, the system generates, based on the decentralized version of the global ML model after the N rounds and based on the centralized version of the global ML model after the M rounds, an averaged version of the global ML model (e.g., as described with respect to FIGS. 1A and 1D). Notably, since the M rounds of centralized learning are performed at the remote system, the system need not transmit data to any client devices prior to initiating any of the M rounds of centralized learning and need not receive any updates from the client devices. Accordingly, the system can perform many more rounds of centralized learning than decentralized learning over the same period of time. Put another way, M can be orders of magnitude larger than N.

At block 576, the system determines whether one or more conditions for causing the global ML model to be deployed are satisfied (e.g., as described with respect to FIGS. 1A and 1D). If, at an iteration of block 576, the system determines that the one or more conditions for causing the global ML model to be deployed are not satisfied, then the system returns to blocks 554 and 564 to initiate an additional N rounds of decentralized learning of the global ML model and an additional M rounds of centralized learning of the global ML model. If, at an iteration of block 576, the system determines that the one or more conditions for causing the global ML model to be deployed are satisfied, then the system proceeds to block 578. Notably, for the additional N rounds of decentralized learning and the additional M rounds of centralized learning of the global ML model, the system can cause the averaged version of the global ML model to be distributed to any client devices participating in the decentralized learning of the global ML model and/or subsequently utilized by the remote system.

At block 578, the system causes the averaged version of the global ML model to be deployed as the global ML model. As described with respect to FIGS. 1A and 1D, the system can continually update the same averaged version of the global ML model, and the final averaged version of the global ML model can be the global ML model that is deployed.

Turning now to FIG. 6, a block diagram of an example computing device 610 that may optionally be utilized to perform one or more aspects of techniques described herein is depicted. In some implementations, one or more of a client device, cloud-based automated assistant component(s), and/or other component(s) may comprise one or more components of the example computing device 610.

Computing device 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computing device 610. Network interface subsystem 616 provides an interface to outside networks and is coupled to corresponding interface devices in other computing devices.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 610 to the user or to another machine or computing device.

Storage subsystem 624 stores programming and data constructs that provide the functionality of some or all of the modules described herein. For example, the storage subsystem 624 may include the logic to perform selected aspects of the methods disclosed herein, as well as to implement various components depicted in FIGS. 1A-1D

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computing device 610 communicate with each other as intended. Although bus subsystem 612 is shown schematically as a single bus, alternative implementations of the bus subsystem may use multiple busses.

Computing device 610 can be of varying types including a workstation, server, computing cluster, blade server, server farm, or any other data processing system or computing device. Due to the ever-changing nature of computers and networks, the description of computing device 610 depicted in FIG. 6 is intended only as a specific example for purposes of illustrating some implementations. Many other configurations of computing device 610 are possible having more or fewer components than the computing device depicted in FIG. 6.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method performed by one or more remote processors of a remote system is provided and includes: initiating a given round of decentralized learning of a global machine learning (ML) model; and during the given round of decentralized learning of the global ML model: receiving, from a plurality of corresponding client devices, a plurality of client updates for the global ML model; identifying a checkpoint version of the global ML model that is stored remotely at the remote system; generating, based on the checkpoint version of the global ML model and based on the plurality of client updates received from the plurality of corresponding client devices, a decentralized version of the global ML model; and generating, based on the checkpoint version of the global ML model and based on the decentralized version of the global ML model, an averaged version of the global ML model. Each of the plurality of client updates is generated locally at a given one of the plurality of corresponding client devices based on processing corresponding client data using a corresponding on-device ML model that are corresponding on-device counterparts of the global ML model. The method further includes, in response to determining one or more conditions are satisfied: causing the averaged version of the global ML model or an additional averaged version of the global ML model to be deployed as the global ML model.

These and other implementations of the technology can include one or more of the following features.

In some implementations, the method can further include, prior to initiating the given round of decentralized learning of the global ML model: training, based on server data that is accessible by the remote system, the global ML model; and storing, in remote memory of the remote system, the global ML model as the checkpoint version of the global ML model.

In some versions of those implementations, the method can further include, prior to receiving the plurality of client updates for the global ML model from the plurality of corresponding client devices: transmitting, to each of the plurality of corresponding client devices and over one or more networks, the global ML model or weights of the global ML model. Transmitting the global ML model or the weights of the global ML model to each of the plurality of corresponding client devices can cause each of the plurality of corresponding client devices to store the global ML model or the weights of the global ML model in corresponding on-device storage as the corresponding on-device ML model.

In some implementations, generating the decentralized version of the global ML model based on the checkpoint version of the global ML model and based on the plurality of client updates received from the plurality of corresponding client devices can include updating, based on the plurality of client updates received from the plurality of corresponding client devices, the checkpoint version of the global ML model to generate the decentralized version of the global ML model for the given round of decentralized learning; and storing, in remote memory of the remote system, the decentralized version of the global ML model.

In some versions of those implementations, the plurality of client updates correspond to a plurality of client gradients generated locally at the corresponding client devices, and updating the checkpoint version of the global ML model to generate the decentralized version of the global ML model for the given round of decentralized learning can include updating, based on the plurality of client gradients, the checkpoint version of the global ML model to generate the decentralized version of the global ML model for the given round of decentralized learning.

In additional or alternative versions of those implementations, the plurality of client updates correspond to a plurality of client weights determined locally at the corresponding client devices, and updating the checkpoint version of the global ML model to generate the decentralized version of the global ML model for the given round of decentralized learning can include replacing, based on the plurality of client weights, global weights of the checkpoint version of the global ML model to generate the decentralized version of the global ML model for the given round of decentralized learning.

In some implementations, generating the averaged version of the global ML model based on the checkpoint version of the global ML model and based on the decentralized version of the global ML model can include averaging corresponding weights of the checkpoint version of the global ML model and the decentralized version of the global ML model to generate averaged weights for the averaged version of the global ML model; and storing, in remote memory of the remote system, the averaged version of the global ML model.

In some versions of those implementations, the averaged weights for the averaged version of the global ML model can be weighted averaged weights of the corresponding weights of the checkpoint version of the global ML model and the decentralized version of the global ML model.

In some implementations, the method can further include, in response to determining the one or more conditions are not satisfied: initiating a given additional round of decentralized learning of the global ML model; and during the given additional round of decentralized learning of the global ML model: receiving, from a plurality of corresponding additional client devices, a plurality of additional client updates for further updating the global ML model; generating, based on the decentralized version of the global ML model and based on the plurality of additional client updates received from the plurality of corresponding additional client devices, an updated decentralized version of the global ML model; generating, based on the checkpoint version of the global ML model and based on the updated decentralized version of the global ML model, an additional averaged version of the global ML model. Each of the plurality of additional client updates can be generated locally at a given one of the plurality of corresponding additional client devices based on processing corresponding additional client data using a corresponding additional on-device ML model that are corresponding on-device counterparts of the global ML model. The method can further include, in response to determining the one or more conditions are satisfied: causing the averaged version of the global ML model or the additional averaged version of the global ML model to be deployed as the global ML model.

In some versions of those implementations, the method can further include evaluating the averaged version of the global ML model and the additional averaged version of the global ML model to determine corresponding performance measures for the averaged version of the global ML model and the additional averaged version of the global ML model; and selecting, based on the corresponding performance measures, the averaged version of the global ML model or the additional averaged version of the global ML model to be deployed as the global ML model.

In some implementations, causing the averaged version of the global ML model or the updated averaged version of the global ML model to be deployed as the global ML model can include utilizing the averaged version of the global ML model or the updated averaged version of the global ML model at the remote system.

In some implementations, causing the averaged version of the global ML model or the updated averaged version of the global ML model to be deployed as the global ML model can include transmitting the averaged version of the global ML model or the updated averaged version of the global ML model to the plurality of client devices and a plurality of additional client devices.

In some implementations, the one or more conditions can include one or more of: whether performance of the averaged version of the global ML model or the additional averaged version of the global ML model satisfies a performance threshold, whether a threshold quantity of averaged versions of the global ML model have been generated, whether a threshold quantity of rounds of decentralized learning of the global ML model have been performed, a time of day, or a day of week.

In some implementations, the global ML model can be an audio-based global ML model, and each of the plurality of client updates can be generated locally at a given one of the plurality of corresponding client devices based on processing corresponding audio data generated locally at the given one of the plurality of corresponding client devices and using a corresponding on-device audio-based ML model counterpart that is corresponding on-device counterpart of the audio-based global ML model.

In some implementations, the global ML model can be a vision-based global ML model, and each of the plurality of client updates can be generated locally at a given one of the plurality of corresponding client devices based on processing corresponding vision data generated locally at the given one of the plurality of corresponding client devices and using a corresponding on-device vision-based ML model counterpart that is corresponding on-device counterpart of the vision-based global ML model.

In some implementations, the global ML model can be a text-based global ML model, and each of the plurality of client updates can be generated locally at a given one of the plurality of corresponding client devices based on processing corresponding textual data generated locally at the given one of the plurality of corresponding client devices and using a corresponding on-device text-based ML model counterpart that is corresponding on-device counterpart of the text-based global ML model.

In some implementations, a method performed by one or more remote processors of a remote system is provided and includes: initiating N rounds of decentralized learning of a global machine learning (ML) model (e.g., where N is a positive integer that is one or greater than one); and during a given round of decentralized learning of the global ML model of the N rounds of decentralized learning of the global ML model: receiving a plurality of client updates from a plurality of corresponding client devices; identifying a checkpoint version of the global ML model that is stored remotely at the remote system; and updating, based on the checkpoint version of the global ML model and based on the plurality of client updates received from the plurality of corresponding client devices, a decentralized version of the global ML model. Each of the plurality of client updates is generated locally at a given one of the plurality of corresponding client devices based on processing corresponding client data using a corresponding on-device ML model that are corresponding on-device counterparts of the global ML model. The method further includes: subsequent to the N rounds of decentralized learning of the global ML model: generating, based on the checkpoint version of the global ML model and based on the decentralized version of the global ML model, an averaged version of the global ML model; and in response to determining the one or more conditions are satisfied: causing the averaged version of the global ML model or an additional averaged version of the global ML model to be deployed as the global ML model.

These and other implementations of the technology can include one or more of the following features.

In some implementations, updating the decentralized version of the global ML model based on the checkpoint version of the global ML model and based on the plurality of client updates received from the plurality of corresponding client devices and during the given round of decentralized learning of the global ML model can include updating, based on the plurality of client updates received from the plurality of corresponding client devices, the checkpoint version of the global ML model.

In some implementations, generating the averaged version of the global ML model based on the checkpoint version of the global ML model and based on the decentralized version of the global ML model can include averaging corresponding weights of the checkpoint version of the global ML model and the decentralized version of the global ML model from a most recent round of decentralized learning of the global ML model to generate averaged weights for the averaged version of the global ML model; and storing, in remote memory of the remote system, the averaged version of the global ML model.

In some versions of those implementations, the averaged weights for the averaged version of the global ML model can be weighted averaged weights of the corresponding weights of the checkpoint version of the global ML model and the decentralized version of the global ML model.

In some implementations, the method can further include, during a given additional round of decentralized learning of the global ML model of the N rounds of decentralized learning of the global ML model: receiving, from a plurality of corresponding additional client devices, a plurality of additional client updates for further updating the global ML model; and further updating, based on the decentralized version of the global ML model and based on the plurality of additional client updates received from the plurality of corresponding additional client devices, the decentralized version of the global ML model. each of the plurality of additional client updates can be generated locally at a given one of the plurality of corresponding additional client devices based on processing corresponding additional client data using a corresponding additional on-device ML model that are corresponding on-device counterparts of the global ML model.

In some implementations, the method can further include, in response to determining that the one or more conditions are not satisfied: initiating N additional rounds of decentralized learning of the global ML model; subsequent to the N additional rounds of decentralized learning of the global ML model: generating, based on the checkpoint version of the global ML model and based on the decentralized version of the global ML model, an additional averaged version of the global ML model; and in response to determining the one or more conditions are satisfied: causing the averaged version of the global ML model or the additional averaged version of the global ML model to be deployed as the global ML model.

In some versions of those implementations, the method can further include, prior to receiving a plurality of additional client updates for the global ML model from a plurality of corresponding additional client devices during a given additional round of decentralized learning of the global ML model of the N additional rounds of decentralized learning of the global ML model: transmitting, to each of the plurality of corresponding client devices and over one or more networks, the averaged version of the global ML model or weights of the averaged version of the global ML model. Transmitting the averaged version of the global ML model or weights of the averaged version of the global ML model can cause each of the plurality of corresponding additional client devices to store the averaged version of the global ML model or weights of the averaged version of the global ML model in corresponding on-device storage as the corresponding on-device ML model.

In some implementations, N is a configurable parameter.

In some implementations, a method performed by one or more remote processors of a remote system is provided and includes: initiating N rounds of decentralized learning of a global machine learning (ML) model and M rounds of centralized learning of the global ML model (e.g., where N is a positive integer that is one or greater than one, and where M is a positive integer that is one or greater than one); and during a given round of decentralized learning of the global ML model of the N rounds of decentralized learning of the global ML model: receiving a plurality of client updates from a plurality of corresponding client devices; identifying a checkpoint version of the global ML model that is stored remotely at the remote system; and updating, based on the checkpoint version of the global ML model and based on the plurality of client updates received from the plurality of corresponding client devices, a decentralized version of the global ML model. Each of the plurality of client updates is generated locally at a given one of the plurality of corresponding client devices based on processing corresponding client data using a corresponding on-device ML model that are corresponding on-device counterparts of the global ML model. The method further includes, during a given round of centralized learning of the global ML model of the M rounds of centralized learning of the global ML model: obtaining corresponding server data that is accessible by the remote system; processing, using a centralized version of the global ML model that initially corresponds to the checkpoint version of the global ML model, the corresponding server data to generate a corresponding remote update for the global ML model; and updating, based on the checkpoint version of the global ML model and based on the corresponding remote update generated remotely at the remote system, the centralized version of the global ML model. The method further includes, subsequent to the N rounds of decentralized learning of the global ML model and subsequent to the M rounds of centralized learning of the global ML model: generating, based on the decentralized version of the global ML model and the centralized version of the global ML model, an averaged version of the global ML model; and in response to determining the one or more conditions are satisfied: causing the averaged version of the global ML model to be deployed as the global ML model.

These and other implementations of the technology can include one or more of the following features.

In some implementations, generating the averaged version of the global ML model based on the decentralized version of the global ML model and the centralized version of the global ML model can include averaging corresponding weights of the decentralized version of the global ML model from a most recent round of decentralized learning of the global ML model and the centralized version of the global ML model from a most recent round of centralized learning of the global ML model to generate averaged weights for the averaged version of the global ML model; and storing, in remote memory of the remote system, the averaged version of the global ML model.

In some versions of those implementations, the averaged weights for the averaged version of the global ML model can be weighted averaged weights of the corresponding weights of the decentralized version of the global ML model and the centralized version of the global ML model.

In some implementations, the method can further include, during a given additional round of decentralized learning of the global ML model of the N rounds of decentralized learning of the global ML model: receiving, from a plurality of corresponding additional client devices, a plurality of additional client updates for further updating the global ML model; and further updating, based on the decentralized version of the global ML model and based on the plurality of additional client updates received from the plurality of corresponding additional client devices, the decentralized version of the global ML model. Each of the plurality of additional client updates can be generated locally at a given one of the plurality of corresponding additional client devices based on processing corresponding additional client data using a corresponding additional on-device ML model that are corresponding on-device counterparts of the global ML model.

In some versions of those implementations, the method can further include, during a given additional round of centralized learning of the global ML model of the M rounds of decentralized learning of the global ML model: obtaining corresponding additional server data that is accessible by the remote system; processing, using the centralized version of the global ML model, the corresponding additional server data to generate a corresponding additional remote update for the global ML model; and further updating, based on the centralized version of the global ML model and based on the corresponding additional remote update for the global ML model, the centralized version of the global ML model.

In some implementations, the method can further include, in response to determining that the one or more conditions are not satisfied: initiating N additional rounds of decentralized learning of the global ML model and M additional rounds of centralized learning of the global ML model; subsequent to the N additional rounds of decentralized learning of the global ML model and subsequent to the M additional rounds of centralized learning of the global ML model: updating, based on the decentralized version of the global ML model and the centralized version of the global ML model, the averaged version of the global ML model; and in response to determining the one or more conditions are satisfied: causing the averaged version of the global ML model or the additional averaged version of the global ML model to be deployed as the global ML model.

In some versions of those implementations, the method can further include, prior to receiving a plurality of additional client updates for the global ML model from a plurality of corresponding additional client devices during a given additional round of decentralized learning of the global ML model of the N additional rounds of decentralized learning of the global ML model: transmitting, to each of the plurality of corresponding client devices and over one or more networks, the averaged version of the global ML model or weights of the averaged version of the global ML model. Transmitting the averaged version of the global ML model or weights of the averaged version of the global ML model can cause each of the plurality of corresponding additional client devices to store the averaged version of the global ML model or weights of the averaged version of the global ML model in corresponding on-device storage as the corresponding on-device ML model.

In some implementations, N can be a configurable parameter, and M can be a separate configurable parameter. In some versions of those implementations, M is larger than N.

Various implementations can include a non-transitory computer readable storage medium storing instructions executable by one or more processors (e.g., central processing unit(s) (CPU(s)), graphics processing unit(s) (GPU(s)), digital signal processor(s) (DSP(s)), and/or tensor processing unit(s) (TPU(s)) to perform a method such as one or more of the methods described herein. Other implementations can include an automated assistant client device (e.g., a client device including at least an automated assistant interface for interfacing with cloud-based automated assistant component(s)) that includes processor(s) operable to execute stored instructions to perform a method, such as one or more of the methods described herein. Yet other implementations can include a system of one or more servers that include one or more processors operable to execute stored instructions to perform a method such as one or more of the methods described herein.

What is claimed is:

1. A method implemented by one or more remote processors of a remote system, the method comprising:
initiating a given round of decentralized learning of a global machine learning (ML) model;
during the given round of decentralized learning of the global ML model:
receiving, from a plurality of corresponding client devices, a plurality of client updates for the global ML model, wherein each of the plurality of client updates is generated locally at a given one of the plurality of corresponding client devices based on processing corresponding client data using a corresponding on-device ML model that are corresponding on-device counterparts of the global ML model;
identifying a checkpoint version of the global ML model that is stored remotely at the remote system;
generating, based on the checkpoint version of the global ML model and based on the plurality of client updates received from the plurality of corresponding client devices, a decentralized version of the global ML model; and
generating, based on the checkpoint version of the global ML model and based on the decentralized version of the global ML model, an averaged version of the global ML model; and
in response to determining one or more conditions are satisfied:
causing the averaged version of the global ML model or an additional averaged version of the global ML model to be deployed as the global ML model.

2. The method of claim 1, further comprising:
prior to initiating the given round of decentralized learning of the global ML model:
training, based on server data that is accessible by the remote system, the global ML model; and
storing, in remote memory of the remote system, the global ML model as the checkpoint version of the global ML model.

3. The method of claim 2, further comprising:
prior to receiving the plurality of client updates for the global ML model from the plurality of corresponding client devices:
transmitting, to each of the plurality of corresponding client devices and over one or more networks, the global ML model or weights of the global ML model, wherein transmitting the global ML model or the weights of the global ML model to each of the plurality of corresponding client devices causes each of the plurality of corresponding client devices to store the global ML model or the weights of the global ML model in corresponding on-device storage as the corresponding on-device ML model.

4. The method of claim 1, wherein generating the decentralized version of the global ML model based on the checkpoint version of the global ML model and based on the plurality of client updates received from the plurality of corresponding client devices comprises:
updating, based on the plurality of client updates received from the plurality of corresponding client devices, the checkpoint version of the global ML model to generate the decentralized version of the global ML model for the given round of decentralized learning; and
storing, in remote memory of the remote system, the decentralized version of the global ML model.

5. The method of claim 4, wherein the plurality of client updates correspond to a plurality of client gradients generated locally at the corresponding client devices, and wherein updating the checkpoint version of the global ML model to generate the decentralized version of the global ML model for the given round of decentralized learning comprises:
updating, based on the plurality of client gradients, the checkpoint version of the global ML model to generate the decentralized version of the global ML model for the given round of decentralized learning.

6. The method of claim 4, wherein the plurality of client updates correspond to a plurality of client weights determined locally at the corresponding client devices, and wherein updating the checkpoint version of the global ML model to generate the decentralized version of the global ML model for the given round of decentralized learning comprises:
replacing, based on the plurality of client weights, global weights of the checkpoint version of the global ML model to generate the decentralized version of the global ML model for the given round of decentralized learning.

7. The method of claim 1, wherein generating the averaged version of the global ML model based on the checkpoint version of the global ML model and based on the decentralized version of the global ML model comprises:
averaging corresponding weights of the checkpoint version of the global ML model and the decentralized version of the global ML model to generate averaged weights for the averaged version of the global ML model; and
storing, in remote memory of the remote system, the averaged version of the global ML model.

8. The method of claim 7, wherein the averaged weights for the averaged version of the global ML model are weighted averaged weights of the corresponding weights of the checkpoint version of the global ML model and the decentralized version of the global ML model.

9. The method of claim 1, further comprising:
in response to determining the one or more conditions are not satisfied:
initiating a given additional round of decentralized learning of the global ML model;
during the given additional round of decentralized learning of the global ML model:
receiving, from a plurality of corresponding additional client devices, a plurality of additional client updates for further updating the global ML model, wherein each of the plurality of additional client updates is generated locally at a given one of the plurality of corresponding additional client devices based on processing corresponding additional client data using a corresponding additional on-device ML model that are corresponding on-device counterparts of the global ML model;
generating, based on the decentralized version of the global ML model and based on the plurality of additional client updates received from the plurality of corresponding additional client devices, an updated decentralized version of the global ML model;
generating, based on the checkpoint version of the global ML model and based on the updated decentralized version of the global ML model, an additional averaged version of the global ML model; and
in response to determining the one or more conditions are satisfied:
causing the averaged version of the global ML model or the additional averaged version of the global ML model to be deployed as the global ML model.

10. The method of claim 9, further comprising:
evaluating the averaged version of the global ML model and the additional averaged version of the global ML model to determine corresponding performance measures for the averaged version of the global ML model and the additional averaged version of the global ML model; and
selecting, based on the corresponding performance measures, the averaged version of the global ML model or the additional averaged version of the global ML model to be deployed as the global ML model.

11. The method of claim 1, wherein causing the averaged version of the global ML model or the updated averaged version of the global ML model to be deployed as the global ML model comprises utilizing the averaged version of the global ML model or the updated averaged version of the global ML model at the remote system.

12. The method of claim 1, wherein causing the averaged version of the global ML model or the updated averaged version of the global ML model to be deployed as the global ML model comprises transmitting the averaged version of the global ML model or the updated averaged version of the global ML model to the plurality of client devices and a plurality of additional client devices.

13. The method of claim 1, wherein the one or more conditions include one or more of: whether performance of the averaged version of the global ML model or the additional averaged version of the global ML model satisfies a performance threshold, whether a threshold quantity of averaged versions of the global ML model have been generated, whether a threshold quantity of rounds of decentralized learning of the global ML model have been performed, a time of day, or a day of week.

14. The method of claim 1, wherein the global ML model is an audio-based global ML model, and wherein each of the plurality of client updates is generated locally at a given one of the plurality of corresponding client devices based on processing corresponding audio data generated locally at the given one of the plurality of corresponding client devices and using a corresponding on-device audio-based ML model counterpart that is corresponding on-device counterpart of the audio-based global ML model.

15. The method of claim 1, wherein the global ML model is a vision-based global ML model, and wherein each of the plurality of client updates is generated locally at a given one of the plurality of corresponding client devices based on processing corresponding vision data generated locally at the given one of the plurality of corresponding client devices and using a corresponding on-device vision-based ML model counterpart that is corresponding on-device counterpart of the vision-based global ML model.

16. The method of claim 1, wherein the global ML model is a text-based global ML model, and wherein each of the plurality of client updates is generated locally at a given one of the plurality of corresponding client devices based on processing corresponding textual data generated locally at the given one of the plurality of corresponding client devices and using a corresponding on-device text-based ML model counterpart that is corresponding on-device counterpart of the text-based global ML model.

17. A method implemented by one or more remote processors of a remote system, the method comprising:
initiating N rounds of decentralized learning of a global machine learning (ML) model, wherein N is a positive integer greater than one;
during a given round of decentralized learning of the global ML model of the N rounds of decentralized learning of the global ML model:
receiving a plurality of client updates from a plurality of corresponding client devices, wherein each of the plurality of client updates is generated locally at a given one of the plurality of corresponding client devices based on processing corresponding client data using a corresponding on-device ML model that are corresponding on-device counterparts of the global ML model;
identifying a checkpoint version of the global ML model that is stored remotely at the remote system; and
updating, based on the checkpoint version of the global ML model and based on the plurality of client updates received from the plurality of corresponding client devices, a decentralized version of the global ML model;
subsequent to the N rounds of decentralized learning of the global ML model:
generating, based on the checkpoint version of the global ML model and based on the decentralized version of the global ML model, an averaged version of the global ML model; and
in response to determining the one or more conditions are satisfied:
causing the averaged version of the global ML model or an additional averaged version of the global ML model to be deployed as the global ML model.

18. The method of claim 17, wherein N is a configurable parameter.

19. A method implemented by one or more remote processors of a remote system, the method comprising:
initiating N rounds of decentralized learning of a global machine learning (ML) model and M rounds of centralized learning of the global ML model, wherein N is a positive integer greater than one, and wherein M is a positive integer greater than one;
during a given round of decentralized learning of the global ML model of the N rounds of decentralized learning of the global ML model:
receiving a plurality of client updates from a plurality of corresponding client devices, wherein each of the plurality of client updates is generated locally at a given one of the plurality of corresponding client devices based on processing corresponding client data using a corresponding on-device ML model that are corresponding on-device counterparts of the global ML model;
identifying a checkpoint version of the global ML model that is stored remotely at the remote system; and
updating, based on the checkpoint version of the global ML model and based on the plurality of client updates received from the plurality of corresponding client devices, a decentralized version of the global ML model;
during a given round of centralized learning of the global ML model of the M rounds of centralized learning of the global ML model:
obtaining corresponding server data that is accessible by the remote system;
processing, using a centralized version of the global ML model that initially corresponds to the checkpoint version of the global ML model, the corresponding server data to generate a corresponding remote update for the global ML model;
updating, based on the checkpoint version of the global ML model and based on the corresponding remote update generated remotely at the remote system, the centralized version of the global ML model;
subsequent to the N rounds of decentralized learning of the global ML model and subsequent to the M rounds of centralized learning of the global ML model:
generating, based on the decentralized version of the global ML model and the centralized version of the global ML model, an averaged version of the global ML model; and
in response to determining the one or more conditions are satisfied:
causing the averaged version of the global ML model to be deployed as the global ML model.

20. The method of claim 19, wherein N is a configurable parameter, wherein M is a separate configurable parameter, and wherein M is larger than N.
